(19) United States
(12) Patent Application Publication
(10) Pub. No.: US 2015/0210194 A1
(43) Pub. Date: Jul. 30, 2015

(54) VEHICLE SEAT

(71) Applicant: TS TECH CO., LTD., Asaka-shi (JP)

(72) Inventor: Masaya Furuta, Tochigi (JP)

(21) Appl. No.: 14/419,299

(22) PCT Filed: Aug. 7, 2013
(86) PCT No.: PCT/JP2013/071416

§ 371 Date: Feb. 3, 2015

(30) Foreign Application Priority Data
Aug. 9, 2012 (JP) 2012-177443
Oct. 12, 2012 (JP) 2012-227316
Jul. 11, 2013 (JP) 2013-145892

(51) Int. Cl. B60N 2/68; B60N 2/70; B60N 2/48

(52) U.S. Cl. CPC B60N 2/68; B60N 2/682; B60N 2/48; B60N 2/7094

(57) ABSTRACT

Provided is a vehicle seat having a seatback frame formed by combining a plurality of frames, wherein the number of components can be kept small, and functional members can be supported in a highly rigid and highly stable manner. The vehicle seat is configured to include at least a seatback frame for supporting the back of an occupant, and the seatback frame includes at least a frame main body formed by combining a front frame constituting the front portion, and a rear frame constituting the rear portion. In the portion where the front frame and the rear frame are joined, there are formed cylindrical support portions for supporting a headrest, and the support portions are configured having openings for inserting connection members for connecting the headrest and the frame main body.

### CROSS REFERENCE TO RELATED APPLICATIONS

This application is the U.S. national phase of the International Patent Application No. PCT/JP2013/071416, filed Aug. 7, 2013, which claims the benefit of the following Japanese Patent Applications:

| Japanese Patent | |
|---|---|
| Application No. | Date Filed |
| 2012-177443 | Aug. 9, 2012 |
| 2012-227316 | Oct. 12, 2012 |
| 2013-145892 | Jul. 11, 2013 |

the entire content of all being incorporated herein by reference.

### BACKGROUND

Disclosed herein is a vehicle seat with a seat frame as a skeleton, and more particularly, a vehicle seat with a seat frame formed using resin material as formation material.

In general, the vehicle seat is configured by disposing a cushioning material in a frame as a skeleton, and covering the cushioning material with an epidermis material.

The skeletal frame normally includes a seat cushion frame serving as a skeleton of a seat portion, and a seatback frame serving as a skeleton of a backrest. The frame is constructed by directly or indirectly attaching a rear end of the seat cushion frame to a lower end of the seatback frame (for example, indirectly through a recliner mechanism).

These frames include not only the skeletal structure, but also various members. These members exhibit various functions.

As such a function of supporting an occupant, for example, an attachment portion adapted to attach a headrest for holding a head of the occupant is generally provided above the seatback frame.

The headrest is normally attached above the seatback frame as described above. Various techniques have been proposed as an attachment method for the headrest.

That is, the headrest is to hold the head of the occupant, and thus needs to have enough strength to stand even when a large rear force is applied upon significant impact and load thereon.

Thus, in order to satisfy these requirements, various techniques for attaching the headrest to the seatback frame have been developed in the background (see, for example, Japanese Patent Document No. JP 2011-201456 A, (“the '456 Document”)).

The '456 Document discloses a technique regarding the seatback frame.

The seatback frame of the '456 Document is formed by combining a front frame forming a front portion and a rear frame forming a rear portion.

When assembling the front frame and the rear frame, a pillar support hole is formed in an upper portion of the frames, a cylindrical pillar support portion is disposed in the pillar support hole, and through the pillar support portion, and a headrest pillar is attached.

In another embodiment, the pillar support portion is formed to be fixed to the upper portion of the front frame, and the headrest pillar is attached through the pillar support portion.

An occupant support member is disposed between both ends in a width direction of a frame main body to support the occupant sitting on a seat from the backside (see, for example, Japanese Patent Document No. JP 2012-071751 A, (“the '751 Document”)).

The occupant support member as disclosed in the '751 Document is mainly formed of an elastic body, such as a spring. For example, in a case of the vehicle seat, when the vehicle receives rear impact and load, the occupant support member is deformed such that the occupant sinks down to the rear side. Thus, the influences of the rear impact and load on the occupant are relieved.

In order to exhibit the above effects, the occupant support member has to be appropriately attached to the frame main body by being hung on a predetermined portion of the frame main body or the like. Here, in a case where the seatback frame is made of metal, when an attachment portion of the occupant support member is provided in the frame main body, a component serving as the attachment portion is preferably provided in the frame main body by welding.

Under these circumstances, various seatback frames are proposed. Any of such seatback frames support the occupant, and thus needs to be formed with sufficient rigidity.

On the other hand, in recent years, resin material has tended to be used as suitable material for the frame main body in terms of moldability and reduction in weight (see, for example, Japanese Patent Document No. JP 2004-322881 A, (“the '881 Document”)).

In the technique disclosed in the '881 Document, an inner half portion and an outer half portion, which are made of a resin molded product, are assembled together to form a hollow frame having a shape of a closed section.

The assembly is performed by joining through vibration welding between a ridge for welding formed in the outer half portion and a receiver for welding formed in the inner half portion.

The seatback frame disclosed in each of the '456 Document and the '881 Document is formed by combining the front frame constituting the front portion and the rear frame constituting the rear portion. Thus, the seatback frame becomes a seat that can improve its rigidity against impact in the front to back direction and in the right and left direction (seat width direction), and which can hold the shape of the seat while suppressing the damage to a cushioning material and interior material, such as epidermis material.

### SUMMARY

However, such a seatback frame can be improved. That is, in this kind of seatback frame composed of a plurality of frames, a structure for attaching various members can be devised.

For example, some contrivance to the attachment of the headrest is considered herein. In short, some further contrivance can be provided to achieve the high rigidity and the stable support, while suppressing an increase in the number of constituent components.

When setting a component for attachment of the occupant support member to the frame main body made of resin material, the component is difficult to attach by welding.

On the other hand, it can be proposed that a portion of the frame main body is processed to integrally form the attachment portion of the occupant support member with the frame main body. Note that with this structure, when the occupant support member is approximately attached to the frame main body, the attachment portion of the frame main body itself has to ensure its rigidity.

Clearly the attached state of the occupant support member to the frame main body should be maintained to not easily detach the occupant support member from the frame main body. In other words, a structure is preferred which can effectively suppress the occupant support member attached to the frame main body from moving with respect to the frame main body.

A position where the occupant support member is attached to the frame main body needs to be a position appropriate for the occupant to sink reward when the vehicle receives the reward impact and load.

When the occupant support member is attached to the frame main body, it is important to suppress an increase in size of the vehicle seat together with this.

A portion of the frame main body where the occupant support member is attached improves the attachability when attaching the occupant support member, while ensuring the rigidity.

As mentioned above, the attachment state of the occupant support member attached to the frame main body needs to be maintained. More specifically, a structure should be provided that stabilizes the attachment of the occupant support member in the attachment position.

When the seat frame is configured to include the seatback frame in combination with the resin molded product in this way, there poses a problem that a joint method therefor becomes complicated.

That is, the assembly disclosed in the '881 Document described above requires vibration welding, which is not good in terms of working efficiency.

As mentioned above, the seatback frame supports the occupant in the vehicle, and thus is required to have high rigidity. Further, the seatback frame also has functions of supporting the back of the occupant in the vehicle, and absorbing a load. In assembly, the seatback frame is required to have not only the workability, but also the high rigidity.

Various embodiments of the present invention have been made in view of the foregoing problems, and it is an object to provide a vehicle seat that can ensure the rigidity of a portion of a frame main body made of resin material where a functional member is attached.

It is another object to provide a vehicle seat that can more stably supports the functional member with the higher rigidity, while reducing the number of components in a seatback frame formed by combining a plurality of frames.

Further, specifically, the functional members of interest include an occupant support member, a headrest, and the like. For example, the occupant support member may have the following specific objects: to effectively restrict the movement of the occupant support member attached to the frame main body from the frame main body; to achieve a structure having the occupant support member stabilized at an attachment position; to set the attachment position of the occupant support member in the frame main body to a position appropriate for the occupant to sink rearward when the vehicle receives the rear impact and load; to suppress the increase in size of the vehicle seat when attaching the occupant support member to the frame main body; and to improve the attachability of the occupant support member, while ensuring the rigidity of the portion of the frame main body to which the occupant support member is attached.

The above-described problem is solved by various embodiments of a vehicle seat described below. The vehicle seat on which an occupant sits is provided wherein the vehicle seat includes at least a seatback frame that supports a back of the occupant, wherein the seatback frame includes at least a frame main body formed by combining a front frame constituting a front portion and a rear frame constituting a rear portion, wherein a cylindrical support portion for supporting a headrest is formed at a combined portion between the front frame and the rear frame, and wherein the support portion has an opening into which a connection member for coupling between the headrest and the frame main body is inserted.

In this way, the vehicle seat includes the frame main body formed by combining a plurality of frames (front frame and rear frame), which serves as a main component of the seatback frame.

The cylindrical support portion for supporting the headrest is formed in a portion where the front frame and the rear frame are joined, and the support portion is provided with an opening into which a connection member for coupling between the frame main body and the headrest is inserted.

In this way, the support portion is formed in the portion where the front frame and the rear frame are joined without forming another support portion as a separate different member, which can suppress the increase in number of components, and can achieve the stable support of the headrest.

Note that the support portion is formed cylindrically, and has, for example, a section with a substantially U shape, a substantially arc shape, a substantially U-like shape, or the like, with a space (or cavity) formed at its inner wall. As long as the space (or area) is shaped to be capable of holding the connection member, the support portion may have any shape. The term “cylindrical shape” as used herein implies a wide range of the cylindrical shape as a concept.

The support portion may be formed in a cylindrical shape, and further in such a shape, the shape of the space (cavity) (that is, the shape formed by the inner wall portion) is preferably formed in a shape along the connection member.

With this arrangement, the connection member can be held (nipped) more effectively.

In a specific example, the support portion is supposed to be formed by bending any one of the front frame and the rear frame. With this arrangement, only one frame needs to be bent, which can easily form the support portion as compared to the case in which both frames are bent.

Specifically, as described in an embodiment, when being formed on the front side of the front frame, the support portion is preferred because the space for movement (sinking) of the occupant can be ensured.

Further, as described in an embodiment, preferably, a plurality of the support portions is formed, and a convex portion protruding forward or rearward is formed between the support portions.

With this arrangement, the rigidity of the surroundings of the support portion is improved.

That is, the convex portion is integrally formed, which does not need the reinforcement of another member or the like, and thus can ensure the higher rigidity, while suppressing the increase in size of the vehicle seat.

In an embodiment, a front side end of the convex portion is positioned on a rear side with respect to a front side end of the support portion.

With this arrangement, the uncomfortable feeling to the occupant due to the provision of the convex portion can be prevented.

Further, as described in an embodiment, preferably, the frame main body is configured in a frame shape, comprising side frames disposed spaced apart from each other in a right and left direction, a lower frame that bridges lower ends of the side frames, and an upper frame that bridges upper ends of the side frames, wherein the support portion is formed in the upper frame, and wherein the other one of the front frame and the rear frame different from the frame with the support portion formed therein is provided with a flange that is positioned in the vicinity of the support portion in an assembly state.

In this way, the flange is provided, which can improve the rigidity of the frame.

The support portion can be formed in the frame that ensures the higher rigidity, thereby enhancing the supporting stability of the headrest.

In an embodiment, the flange is disposed in a position that does not interfere with the connection member, while the frame main body is assembled and the connection member for coupling between the headrest and the frame main body is disposed in the support portion.

Further, specifically, as described in an embodiment, the flange is preferably formed under the connection member.

This arrangement is preferred because the contact between the connection member and the flange can be effectively suppressed.

In a further specific example, while a joint portion is disposed in the support portion, a cutout portion is formed under an interference portion between the support portion and the joint portion in the frame on a side with the support portion formed, thereby enabling the further reduction in weight of the vehicle seat.

As described in an embodiment, a bonding surface to which an adhesive is applied is preferably formed at a surface disposed in a vehicle width direction of the support portion, which can ensure the attachment rigidity of the support portion.

Further, as described in an embodiment, preferably, the seatback frame comprises an occupant support member disposed between both ends of the frame main body in a width direction of the vehicle seat, the occupant support member being adapted to support the occupant sitting on the vehicle seat, from the back side, wherein a front side nipping portion formed in a front frame piece and a back side nipping portion formed in a rear frame piece are engaged with each other to form the frame main body, and wherein the occupant support member is nipped between the front side nipping portion and the back side nipping portion, thereby being attached to the frame main body.

In the above-mentioned seatback frame, the occupant support member is attached to the frame main body by being nipped between the front frame and the rear frame which constitute the frame main body. The parts of the respective frames that nip the occupant support member are those engaged between the frames when combining the frames with each other so that the rigidity of the parts becomes relatively high. Thus, the above-mentioned seatback frame can ensure the rigidity of the portion of the frame main body made of resin with the occupant support member attached thereto.

As described in an embodiment, preferably, the vehicle seat is formed to have a resin seat frame including the seatback frame as a skeleton, and the front frame and the rear frame are joined with each other through a latch.

In this way, the resin seat frame formed by combination of the front frame and the rear frame can be assembled with sufficient rigidity, thereby improving the assembly workability.

That is, the use of the latch can easily combine the resin frames, and can also ensure the high assembly rigidity as compared to the case of bonding the frames, for example, only by an adhesive.

Note that a member as the latch is not specifically limited as long as the member can couple the front frame and the rear frame. For example, a “rivet” can be preferably used.

The rivet can easily perform coupling of the frames by being caulked, and can effectively prevent the occurrence of cracks or the like due to the application of a strong fastening force, while ensuring the rigidity.

In an embodiment, the seat frame is the seatback frame; the frame main body constituting the seatback frame is formed in a frame shape, comprising side frames disposed spaced apart from each other in a right and left direction, a lower frame bridging lower ends of the side frames, and an upper frame including the support portion while bridging upper ends of the side frames; and a joint portion with the latch is preferably formed in at least one position on a lower side of the support portion.

This arrangement can effectively prevent the front frame and the rear frame from being peeled off from each other in the lower portion of the support portion (a portion where the headrest pillar is disposed) to which a large load from the headrest is applied.

Further, the rigidity of the portion to which the large load is applied can be kept high.

In an embodiment, preferably, the joint portions with the latches are provided, and the joint portions with the latches are positioned to sandwich therebetween a lower side of the support portion.

With this arrangement, both ends of a base of the support portion serving as an attachment portion for the headrest which receives the load of the occupant's head can be joined by the latches, thereby ensuring the higher rigidity, preventing the peeling of the front and back surfaces of the portion.

Further, in an embodiment, preferably, the joint portion with the latch is further provided in the side frame, and a direction in which the latch penetrates the upper frame is different from a direction in which the another latch penetrates the side frame.

With this arrangement, the upper portion and the side portion can adjust an angle in a fastening direction so that the fastening direction can change according to the direction in which the upper portion and the side portion can be easily peeled off, thereby ensuring the higher attachment rigidity.

As described in an embodiment, preferably, a claw portion is provided on one of the front frame and the rear frame, a slit capable of being engaged with the claw portion is provided on the other one of the front frame and the rear frame; and the claw portion is retained in the slit so that the front frame and the rear frame are joined to each other.

With this arrangement, the claw portion is engaged with the slit, which can perform positioning by the engagement structure in assembly, while ensuring the higher attachment rigidity, thereby improving the assembly workability.

In an embodiment, preferably, the front frame is provided with a protruding hole, the claw portion protrudes from a portion of a peripheral edge of the protruding hole, the rear frame is provided with a retaining protrusion that protrudes forward, the slit is formed in the retaining protrusion, and the retaining protrusion is exposed forward from the protruding hole.

More specifically, as described in an embodiment, preferably, the protruding hole is formed in an upper portion, and the claw portion extends from a peripheral edge of the protruding hole in the vicinity of the latch; the slit is formed by being cut in a position of the retaining protrusion that matches a position where the claw portion is disposed when the front frame and the rear frame are combined; and a free end of the claw portion is inserted into the slit from a front side toward a rear side, while the free end of the claw portion is disposed inside a concave portion at a backside of the retaining protrusion.

With this arrangement, the claw portion is engaged with the slit, which can ensure the higher attachment rigidity.

Since the retaining protrusion is disposed to expose forward from the protruding hole, the positioning in assembly can also be performed even in the structure, thereby improving the assembly workability.

Further, the free end of the claw portion is disposed on the backside of the retaining protrusion (that is, which is a concave portion as viewed from the backside), which can prevent the free end of the claw portion from protruding toward the outside of the back surface.

As described in an embodiment, the claw portion and the slit are disposed in at least one of a position outside the support portion and a position between the support portions.

Thus, for example, the claw portion and the slit are disposed outside the support portion (that is, in the position in the vicinity of a shoulder portion of the seatback frame), or between the headrest pillars (corresponding to the central portion of the upper portion).

In this way, the engagement relationship can be established by providing the claw portion and the slit at the outer end of the upper portion of the structure of the seatback frame extending in the width direction, or a portion to which a force from the headrest pillar is applied, thereby ensuring the higher rigidity.

In this portion, the engagement relationship can be established, thereby effectively preventing the peeling of the front frame and the rear frame.

As to a specific arrangement, as described in an embodiment, the vehicle seat further comprises a plurality of the claw portions, wherein the claw portions are formed in such positions as to sandwich the lower portion of the support portion therebetween. Thus, preferably, the rigidity of the portion to which the large load is applied can be ensured, thereby preventing the peeling of the front and back surfaces of the portion.

Further, as described in an embodiment, at least the one claw portion is formed in between the formed latches. Thus, preferably, the number of used latches can be decreased, and the peeling of the front and back surfaces of the portion can be effectively prevented. Moreover, the rigidity of the portion can be ensured.

As described in an embodiment, at least the one latch is disposed between the claw portion and the support portion, thereby reinforcing the portion of the protruding hole with the claw portion formed to ensure the rigidity of the portion.

Further, as described in an embodiment, preferably, a pillar retaining hole for retaining the headrest pillar is formed at a side surface of the support portion, and the latch is disposed in a position other than an opening of the pillar retaining hole and in the vicinity of the pillar retaining hole.

Normally, the headrest pillar is attached to a headrest pillar disposing portion through a member called a guide member.

The guide member includes a retaining claw portion for retaining, and the pillar retaining hole for retaining the retaining claw portion is formed in the headrest pillar disposing portion.

Thus, the latch is disposed in the position other than the pillar retaining hole, which can prevent the inhibition of the workability upon attaching or detaching the headrest pillar, and can ensure the rigidity of the portion.

According to various embodiments, since the cylindrical support portion is formed in a portion where the front frame and the rear frame are joined without forming another support portion as a separate member, it is possible to suppress the increase in number of components, and to achieve the stable supporting of the headrest.

According to various embodiments, it is possible to ensure the space for movement (sinking) of the occupant.

According to various embodiments, it is possible to ensure the higher rigidity of the vehicle seat, while suppressing the increase in size of the vehicle seat.

According to various embodiments, the uncomfortable feeling to the occupant due to the provision of the convex portion can be suppressed, thereby improving the riding comfort.

According to various embodiments, since the support portion with the higher rigidity ensured and the flange around the support portion are provided, it is possible to enhance the supporting stability of the headrest.

According to various embodiments, it is possible to effectively suppress the contact between the connection member and the flange.

According to various embodiments, the flange is formed on the lower side, and thus can be displaced. Thus, the flange can be increased in size, thereby ensuring the high rigidity of the vehicle seat.

According to various embodiments, it is possible to ensure the attachment rigidity of the support portion.

According to various embodiments, it is possible to provide the seatback frame which ensures the rigidity of a portion of the resin frame main body to which the occupant support member is attached.

According to various embodiments, it is possible to provide the seat frame which ensures the attachment rigidity between the front frame and the rear frame in the frame main body made of the resin material.

Further, the assembly workability of the front frame and the rear frame can be improved.

According to various embodiments, it is possible to effectively prevent the peeling of the front frame and the rear frame in the lower portion of the support portion (headrest pillar disposing portion) to which a large load from the headrest is applied, and to keep the rigidity of the portion high.

According to various embodiments, both sides of the base of the support portion protruding upward with the load applied thereto can be joined together with the high rigidity.

Thus, it is possible to effectively prevent the peeling of the front and back surfaces of the portion.

According to various embodiments, the latches can be disposed in the respective peeling directions, thereby ensuring the higher attachment rigidity, while effectively preventing the respective peeling.

According to various embodiments, it is possible to ensure the high attachment rigidity because of the engagement structure between the claw portion and the slit, and to improve the assembly workability through positioning by use of the engagement structure.

According to various embodiments, it is possible to easily perform the positioning in assembly, while ensuring the high attachment rigidity.

The free end of the claw portion can be effectively prevented from protruding outward of the back surface.

According to various embodiments, it is possible to effectively prevent the peeling of the front frame and the rear frame, while ensuring the higher rigidity of the vehicle seat.

According to various embodiments, it is possible to effectively prevent the peeling of the front and back surfaces of a portion to which a large load is applied, while ensuring the rigidity of the portion.

According to various embodiments, it is possible to effectively prevent the peeling of the front and back surfaces of the portion, while decreasing the number of used latches, which is preferred. The rigidity of the portion can also be ensured.

According to various embodiments, a protruding hole portion with the claw portion formed therein is reinforced to ensure the rigidity of the vehicle seat.

According to various embodiments, it is possible to prevent the interruption of the workability upon attaching and detaching the headrest pillar, and also to ensure the rigidity of the portion.

### BRIEF DESCRIPTION OF THE DRAWINGS

FIG. 1 is a schematic perspective view of a vehicle seat according to a first embodiment of the present invention;

FIG. 2 is a schematic perspective view of a seatback frame according to the first embodiment of the present invention;

FIG. 3 is a front view of the seatback frame according to the first embodiment of the present invention;

FIG. 4 is a rear view of the seatback frame according to the first embodiment of the present invention;

FIG. 5 is an enlarged front view of a main portion of the seatback frame according to the first embodiment of the present invention;

FIG. 6 is an enlarged perspective view of the main portion of the seatback frame according to the first embodiment of the present invention;

FIG. 7 is a vertical cross-sectional view of a headrest guide member according to the first embodiment of the present invention;

FIG. 8 is a cross-sectional view taken along the line A-A of FIG. 5;

FIG. 9 is an explanatory perspective diagram illustrating the headrest guide member according to the first embodiment of the present invention;

FIG. 10 is another explanatory perspective diagram illustrating the headrest guide member according to the first embodiment of the present invention;

FIG. 11 is an explanatory perspective diagram of a flange formed in the seatback frame according to the first embodiment of the present invention;

FIG. 12 is an explanatory perspective diagram illustrating a modified example of the surroundings of the headrest guide member in the first embodiment;

FIG. 13 is a perspective view illustrating the structure of an occupant support member and its surroundings according to the first embodiment of the present invention;

FIG. 14 is a perspective diagram illustrating an attachment structure of the occupant support member, specifically, an enlarged diagram of a range X of FIG. 13 according to the first embodiment of the present invention;

FIG. 15 is another perspective diagram illustrating an attachment structure of the occupant support member, specifically, an overhead view of the attachment structure according to the first embodiment of the present invention;

FIG. 16 is a further perspective diagram illustrating an attachment structure of the occupant support member, specifically, an explanatory diagram of a front side convex portion and a back side convex portion according to the first embodiment of the present invention;

FIG. 17 is a perspective view illustrating the front side convex portion according to the first embodiment of the present invention;

FIG. 18 is a side view of the front side convex portion according to the first embodiment of the present invention;

FIG. 19 is a perspective view showing the back side convex portion according to the first embodiment of the present invention;

FIG. 20 is a cross-sectional view of the back side convex portion according to the first embodiment of the present invention;

FIG. 21 is a cross-sectional diagram illustrating the positional relationship among the front side convex portion, the back side convex portion, and the occupant support member in the first embodiment of the present invention, specifically, a cross-sectional view taken along the line B-B of FIG. 16;

FIG. 22 is a perspective view showing a seat frame of a vehicle seat according to a second embodiment of the present invention;

FIG. 23 is a front view of a seatback frame according to the second embodiment of the present invention;

FIG. 24 is a back view of the seatback frame according to the second embodiment of the present invention;

FIG. 25 is a perspective view illustrating a front surface of an upper portion of the seatback frame according to the second embodiment of the present invention;

FIG. 26 is a perspective view illustrating a rear surface of an upper portion of the seatback frame according to the second embodiment of the present invention;

FIGS. 27A and B are explanatory side view diagrams illustrating a side portion of the seatback frame according to the second embodiment of the present invention;

FIG. 28 is an enlarged view of a Y portion of FIG. 27;

FIG. 29 is a cross-sectional view taken along the line C-C of FIG. 25;

FIG. 30 is a cross-sectional view taken along the line D-D of FIG. 25;

FIG. 31 is an enlarged view of a Z portion of FIG. 30;

FIG. 32 is a cross-sectional view taken along the line E-E of FIG. 25; and

FIG. 33 is an enlarged view of a W portion of FIG. 32.

### DETAILED DESCRIPTION

### First Embodiment

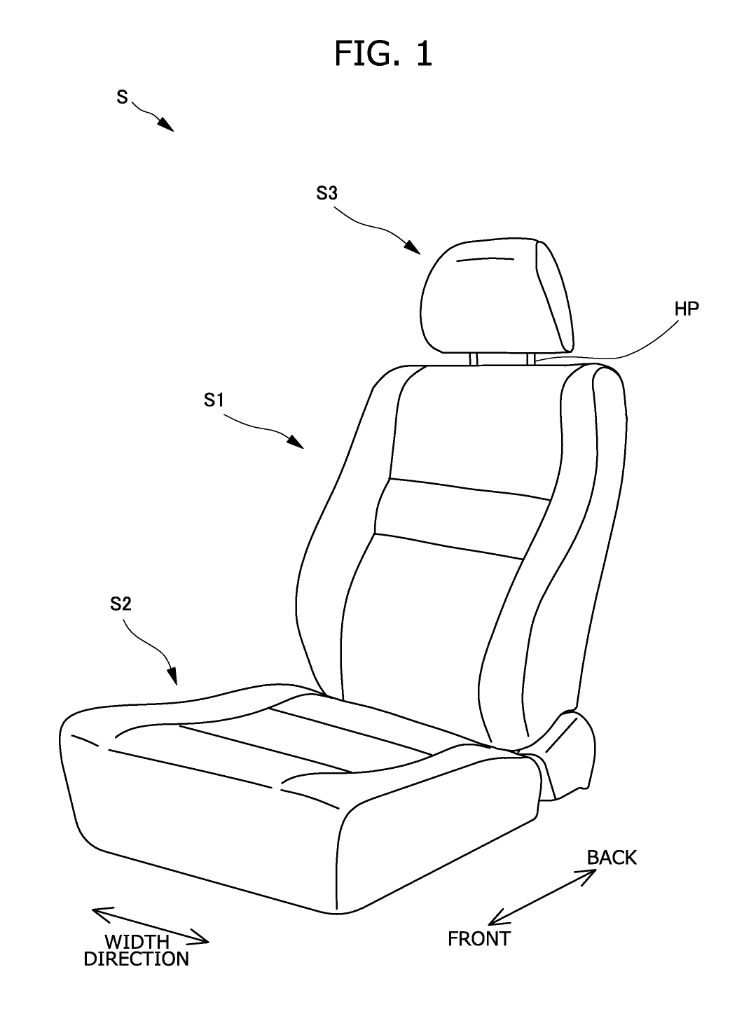

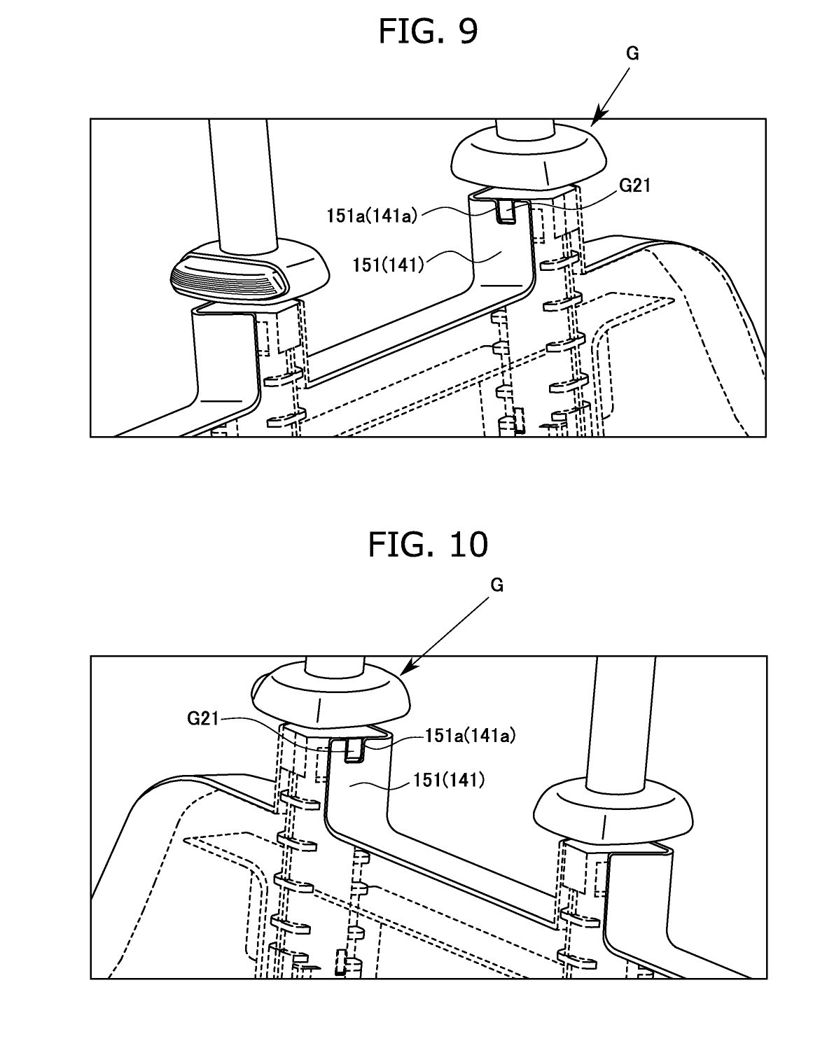

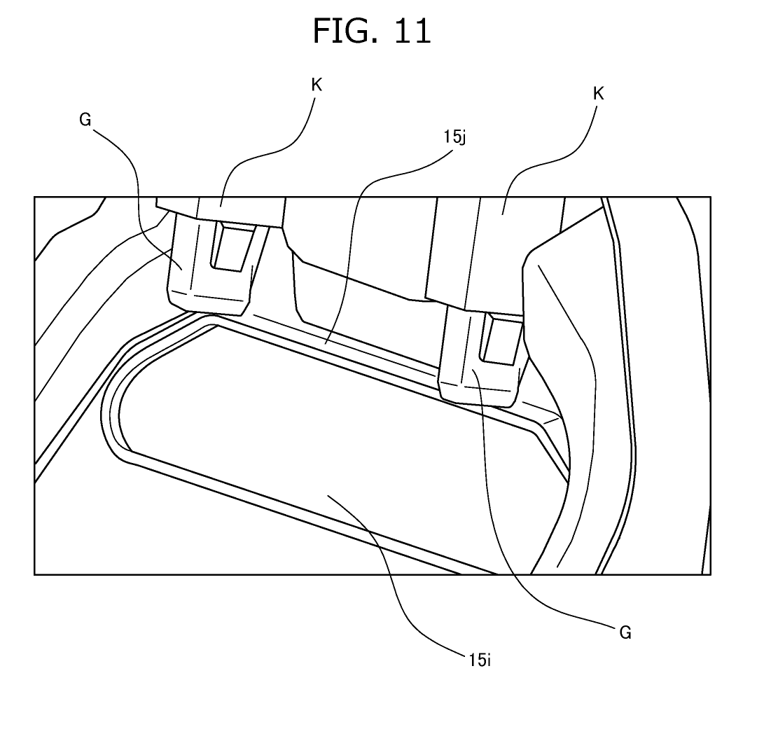

In the following, a vehicle seat according to a first embodiment of the present invention will be described with reference to FIGS. 1 to 21.

Now, a first example of the embodiment of the present invention will be described with reference to the accompanying drawings. However, it is apparent that members, arrangement, and the like to be described later are not intended to restrict the present invention, and can be variously modified according to the scope of the present invention. The term “vehicle” as used in the present specification means movable conveyance on which a seat can be mounted, including a conveyance for surface movement with wheels, such as an automobile or a train, a conveyance other than surface movement, such as an airplane or a ship, and the like.

Here, in the description below, the “front to back direction of the vehicle seat” means a direction identical to the traveling direction of the vehicle, which is hereinafter simply referred to as a “front to back direction”. The term “width direction of the vehicle seat” means a direction identical to the direction along the width of the vehicle, which is hereinafter simply referred to as a “width direction”. The term “vertical direction” means an up to down direction of the vehicle.

Note that the description below indicates, unless otherwise specified, the structure in a state in which the vehicle seat is being used in the vehicle, that is, in a state in which the occupant is sitting on the vehicle seat. The direction and position to be described later mean a direction and position in the above-mentioned state.

Basic Structure of Vehicle Seat S

A vehicle seat S according to the embodiment will be described with reference to FIGS. 1 to 21.

The vehicle seat S according to the embodiment of the present invention (hereinafter, referred to as this embodiment) is an object on which an occupant in the vehicle sits.

As shown in FIG. 1, the vehicle seat S includes a seatback S1 into which the occupant leans back, a seat cushion S2 on which the renal area of the occupant is placed, and a headrest S3 that supports the head of the occupant, as components.

In this way, the vehicle seat S according to this embodiment includes the seatback S1 (back portion), the seat cushion S2, and the headrest S3. The seatback S1 (back portion) and the seat cushion S2 are formed by placing a cushion pad (not shown) on a seat frame, and covering the cushion pad with an epidermis material or the like.

The headrest S3 is formed by disposing a cushion pad material (not shown) around a core (not shown) of a head portion, and covering the cushion pad with an epidermis material. A reference character HP is a headrest pillar that supports the headrest S3.

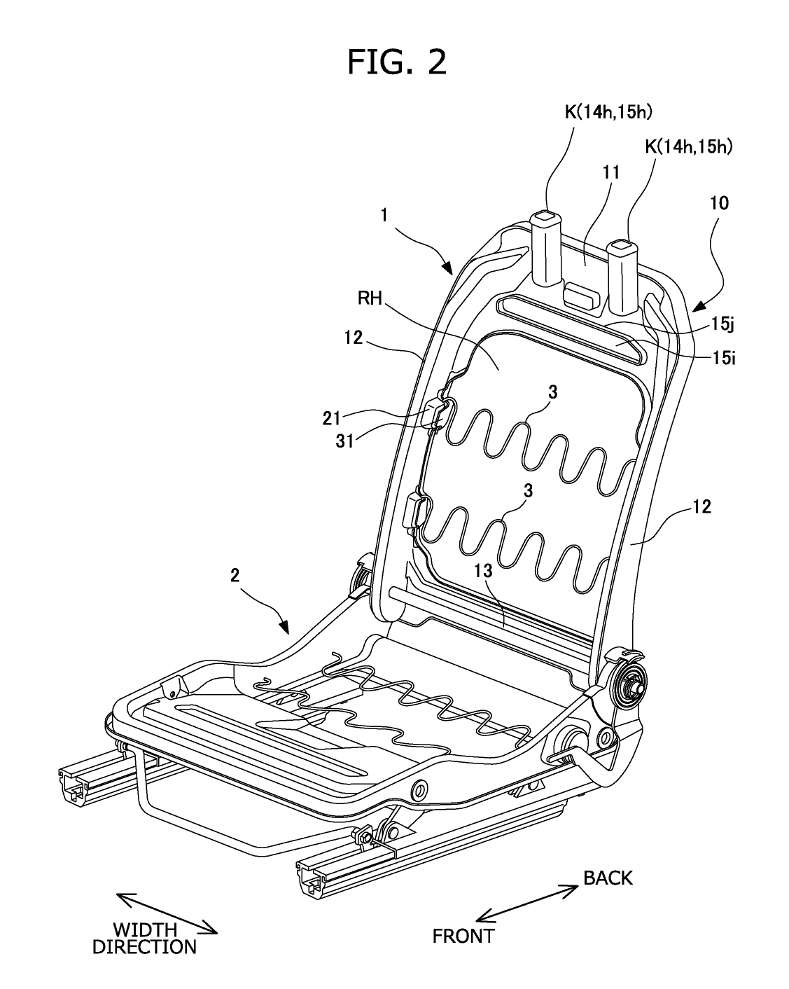

A frame of the vehicle seat S in this embodiment, as shown in FIG. 2, includes a seatback frame 1 constituting the seatback S1, and a seat cushion frame 2 constituting the seat cushion S2 as principal components.

As the seat cushion frame 2 of this embodiment, the known seat cushion frame is used.

For example, the seat cushion frame 2 is formed of a frame having a rectangular shape in a planar view. In particular, in this embodiment, the seat cushion frame is preferably integrally formed of carbon fiber reinforced plastic (CFRP) as resin material.

The seat cushion frame 2 is supported by leg portions. The leg portion has, for example, an inner rail attached thereto. The seat cushion frame 2 is assembled in a sliding manner that can be adjusted to be positioned in the front to back direction between the inner rail and an outer rail set on a floor of the vehicle body.

The rear end of the seat cushion frame 2 is coupled to the seatback frame 1, for example, through a recliner mechanism.

In use of the recliner mechanism, the well-known mechanism may be employed.

Note that as the seat cushion frame 2 and recliner mechanism, the well-known ones may be used, which does not directly relate to the contents of the present application. Thus, a detailed description thereof will be omitted.

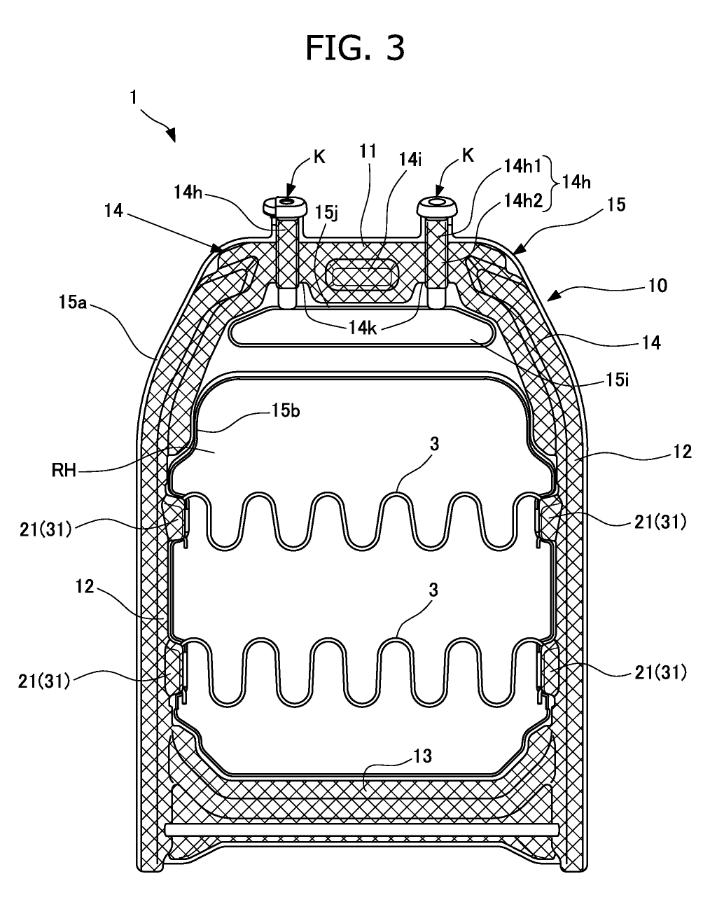

Next, as shown in FIGS. 2 and 3, the seatback frame 1 according to this embodiment includes a frame main body 10 forming a frame body with a rectangular shape in the front view, and an occupant support member 3 formed of a spring (so-called S spring) meandering in an S shape.

The frame main body 10 includes an upper frame 11 formed in a substantially trapezoid shape, a pair of side frames 12 formed spaced apart from each other in the width direction, and a lower frame 13 coupling the lower ends of the side frames 12. As mentioned above, the frame main body 10 is formed as a frame body with a substantially rectangular shape in the front view.

The frame main body 10 according to this embodiment is configured to be divided into two pieces in the front to back direction.

That is, the frame main body 10 is formed by combining a front frame 14 constituting the front portion, and a rear frame 15 constituting the rear portion.

In this embodiment, both the front frame 14 and the rear frame 15 are formed of CFRP as the resin material, and are integrally formed by metallic molding.

Note that the material used for the front frame 14 and the rear frame 15 is not limited to the CFRP, but may be any resin material other than the CFRP, for example, plastic without carbon fiber.

A forming method of the front frame 14 and the rear frame 15 is not limited to a case in which CFRP is charged into a die and integrally molded. Alternatively, the front frame 14 and the rear frame 15 may be formed by any method other than the metallic molding, for example, by laminating sheets formed of resin in a frame shape.

Each of the two front frame 14 and rear frame 15 includes a portion corresponding to the upper frame 11, parts corresponding to the side frames 12, and a portion corresponding to the lower frame 13.

Here, the portion corresponding to the upper frame 11 means a portion of the respective front and rear frames 14 and 15 constituting the upper frame 11 when the front frame 14 and the rear frame 15 are combined with each other.

Likewise, the parts corresponding to the side frames means parts of the respective front and rear frames 14 and 15 constituting the side frames 12 when the front frame 14 and the rear frame 15 are combined with each other.

The portion corresponding to the lower frame 13 means a portion constituting the lower frame 13 when the front frame 14 and the rear frame 15 are combined with each other.

Upon combination of the front frame 14 and the rear frame 15, the hollow frame main body 10 is formed. More specifically, for example, the section taken along the horizontal surface of the side frame 12 has a closed sectional structure.

The frame main body 10 (front frame 14 and rear frame 15) are main components, and will be described in detail later.

The occupant support member 3 is attached to the frame main body 10 in a state of extending along the width direction while meandering in the up and down direction.

In particular, in this embodiment, the occupant support member 3 is disposed in a hole RH having a substantially square shape and surrounded by the upper frame 11, side frames 12, and lower frame 13 of the frame main body 10.

The occupant support member 3 supports the occupant sitting on the vehicle seat S from the back of the occupant during the normal time, while is deformed such that the occupant sinks rearward when the vehicle receives the rear impact and load. In this way, the deformation of the occupant support member 3 relieves the influence of the rear impact and load on the occupant.

In this embodiment, two occupant support members 3 are disposed in the above-mentioned hole RH while being spaced apart from each other in the up and down direction. Note that the presence of at least one of the occupant support members 3 is sufficient, but the number of the occupant support members 3 can be arbitrarily set.

In this embodiment, the occupant support member 3 is disposed in the above-mentioned hole RH by attaching both ends in the width direction of the occupant support member 3 to attachment parts formed in the respective side frames 12.

More specifically, the occupant support member 3 is laid from one side frame 12 to the other side frame 12 along the width direction. By this procedure, the occupant support member 3 is arranged between the side frames 12. In the arrangement position, the occupant support member 3 extends in the width direction, while meandering in the up and down direction.

On the other hand, in this embodiment, a portion of each side frame 12 of the frame main body 10 is provided with the attachment portion for the occupant support member 3. The attachment portion is integrally formed by the CFRP with other parts of the side frame 12.

Structure of Frame Main Body

Next, the frame main body 10 will be described in detail below.

As mentioned above, the frame main body 10 is formed by combining the front frame 14 and the rear frame 15.

FIG. 3 is a front view of the seatback frame 1, illustrating the front frame 14 by diagonal lines for easy understanding. However, this kind of patterning or processing is not applied, and the processing is arbitrary.

First, the front frame 14 will be described.

In the front frame 14, most of a portion thereof corresponding to the upper frame 11, parts thereof corresponding to the side frames 12, and a portion thereof corresponding to the lower frame 13 are bulged toward the front side.

The parts corresponding to the side frames 12 in the front frame 14 are provided with front side nipping portions 21 formed at the inner surfaces of the parts.

The front side nipping portion 21 holds the end of the occupant support member 3 in cooperation with a back side nipping portion 31 to be described later. Thus, the occupant support member 3 is attached to the frame main body 10.

In this embodiment, the two front side nipping portions 21 are formed to be vertically spaced apart from each other in the up and down direction on a side corresponding to one side frame 12 (four nipping portions in total are formed on both sides). The front side nipping portions 21 and 21 separated from each other in the up and down direction are coupled together by a flange formed in the portion corresponding to the side frame 12.

As shown in FIGS. 2, 3, 5, 6, and the like, in this embodiment, parts of the front frame 14 corresponding to the upper frame 11 partially extend along the up and down direction, so that two front-side holding portions 14h and 14h are formed to hold a headrest pillar HP at these parts.

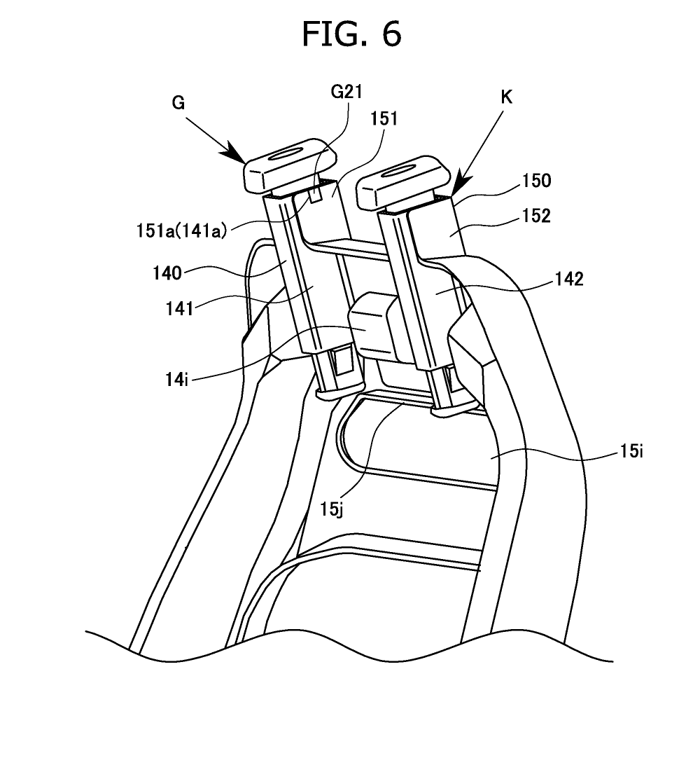

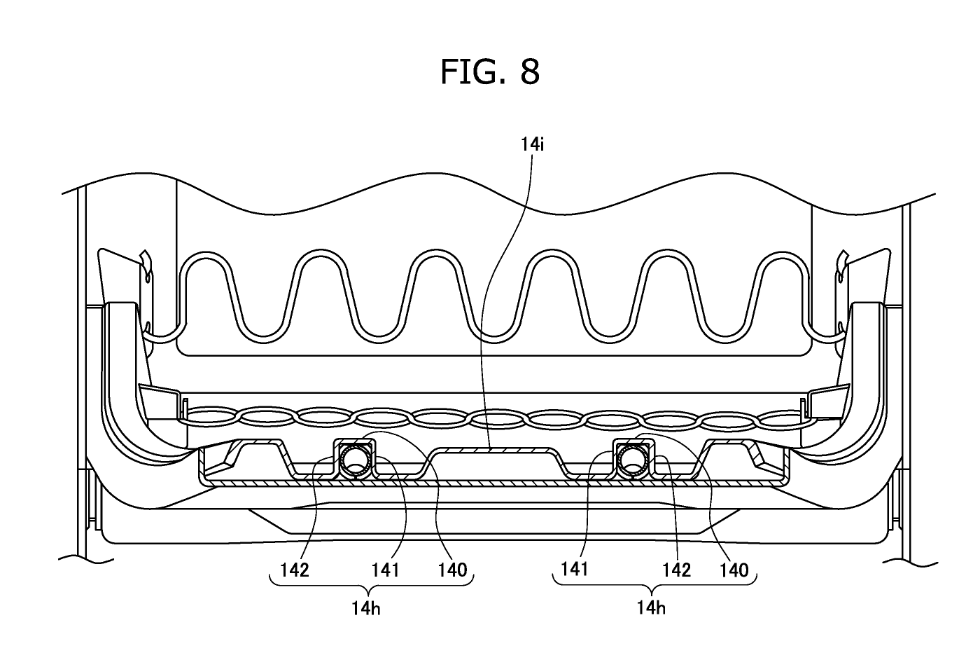

As shown in FIGS. 6 and 8, the front-side holding portions 14h and 14h are formed to protrude forward. When combined with the rear frame 15, the rear frame 15 and the front-side holding portion 14h takes the cylindrical shaped form (in a cylindrical shape with a substantially rectangular section), and an inner hole of the front-side holding portion 14h is configured to extend in the up and down direction.

As shown in FIGS. 6, 9, and 10, the front-side holding portion 14h is provided with a front-side engagement hole portion 141a.

For convenience of explanation, a substantially U-shaped bottom surface of the front-side holding portion 14h is referred to as a “front-side bottom portion 140”, a surface directed inward (each of inner opposed surfaces in both front-side holding portions 14h and 14h) is referred to as a “front-side inner surface 141”, and a surface directed outward is referred to as a “front-side outer surface 142”.

The front-side engagement hole portion 141a is formed in the front-side inner surface 141.

In this embodiment, the front-side engagement hole portion 141a is formed as a substantially rectangular shaped hole that is made by cutting the front-side inner surface 141 downward from its upper end side.

The front-side engagement hole portion 141a communicates with a rear-side engagement hole portion 151a to be described later. An engagement protrusion G21 formed in the headrest guide member G is retained in the communication hole.

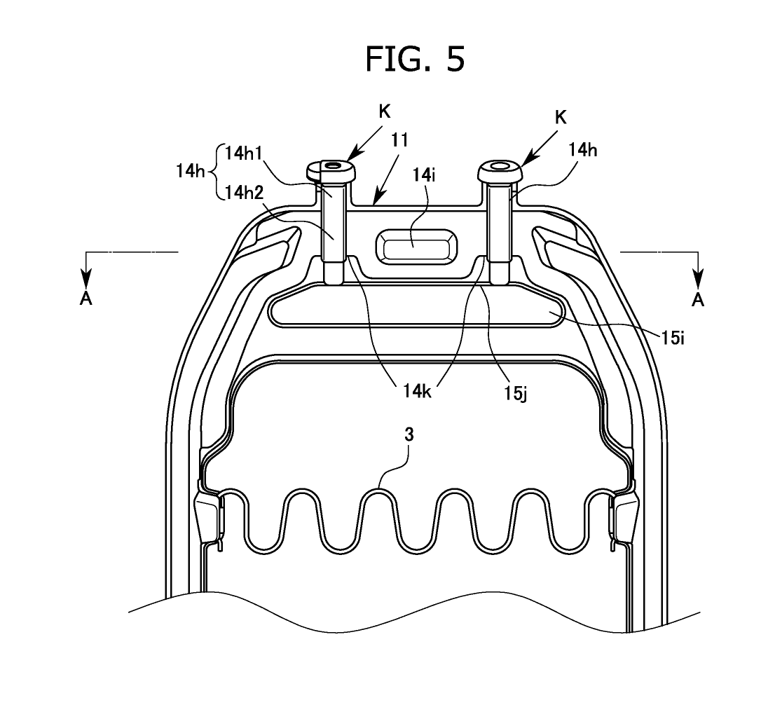

Further, as shown in FIGS. 3 and 5, the lower sides of the front-side holding portions 14h and 14h are cut to form cutout portions 14k and 14k.

This can achieve further reduction in weight of the vehicle seat.

All or portion of the front-side inner surface 141 and front-side outer surface 142 serves as a bonding surface with an adhesive applied thereto.

This can ensure the attachment rigidity of the front-side holding portions 14h, further improving the supporting stability of the headrest.

In this embodiment, the two front-side holding portions 14h and 14h are formed spaced apart from each other in the right and left width direction at both ends of a portion of the front frame 14 corresponding to the upper frame 11. A convex portion 14i protruding forward is formed between two front-side holding portions 14h and 14h.

The convex portion 14i is formed to protrude in a substantially U shape in a cross-sectional view (that is, to form a cup shape with a substantially rectangular bottom surface) with reference to FIGS. 3, 5, 6, 8, and the like.

In this way, the formation of the convex portion 14i can ensure the rigidity of the vehicle seat without increasing its size.

A protruding distance of the convex portion 14i (a distance from a flat surface of the corresponding front frame 14 to the maximum protruding portion) is configured to be smaller than a protruding distance of the front-side holding portion 14h (a distance from the flat surface of the front frame 14 to the maximum protruding portion) (see, especially, FIGS. 6 and 8).

That is, the front end of the convex portion 14i is configured to be positioned at a rear side with respect to the front end of the front-side holding portion 14h.

This can suppress an uncomfortable feeling of the occupant due to the formation of the convex portion 14i.

In this embodiment, a position in the rear frame 15 that matches with the convex portion 14i is made flat.

With this arrangement, the above-mentioned portion is formed in a box shape, which can ensure the high rigidity.

However, the rear frame 15 is not limited thereto, and may be formed such that the position of the rear frame 15 matching with the convex portion 14i may be formed along the shape of the convex portion located in the position.

The shape, size, and number of convex portions 14i are not limited to those described above, and can be modified variously.

For example, the convex portion 14i may be extended in such a size as to couple the front-side holding portions 14h and 14h.

With this arrangement, the rigidity of the structure is further improved, so that the supporting stability of the headrest is further enhance.

Further, the convex portion 14i may extend to couple the lower ends and/or upper ends of the front-side holding portions 14h and 14h.

With this arrangement, the rigidity in the height direction of the pillar abutment portion between the front-side holding portions 14h and 14h can be improved, which further enhances the supporting stability of the headrest.

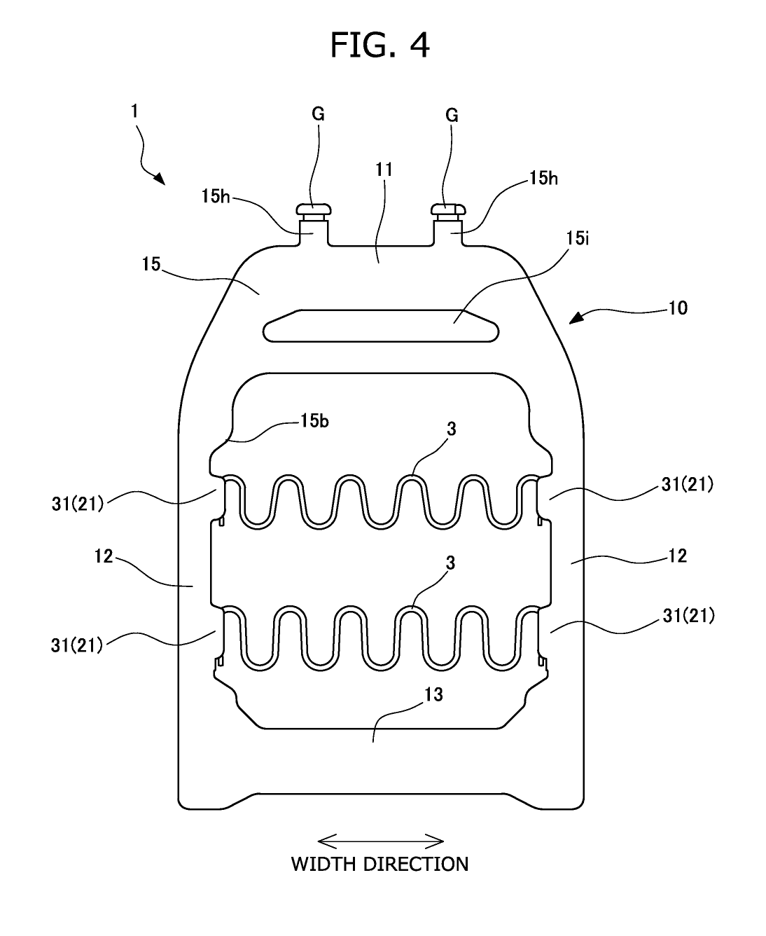

Next, the rear frame 15 will be described with reference to FIG. 4.

In the rear frame 15, most of a portion thereof corresponding to the upper frame 11, parts thereof corresponding to the side frames 12, and a portion thereof corresponding to the lower frame 13 are bulged toward the rear side.

More specifically, an outer edge wall 15a formed along an outer edge of the rear frame 15 and an inner edge wall 15b formed along an inner edge thereof protrude to the front side.

As shown in FIG. 3, a portion of the rear frame 15 corresponding to the upper frame 11 extends upward to form two rear-side holding portions 15h and 15h for holding the headrest pillars HP (headrest guide members G) in cooperation with the front-side holding portions 14h and 14h of the front frame 14.

Further, as shown in FIG. 3, the outer edge of the rear frame 15 is slightly larger than the outer edge of the front frame 14, while the inner edge of the rear frame 15 is slightly smaller than the inner edge of the front frame 14.

In the rear frame 15, a recessed portion is formed between the outer edge wall 15a and the inner edge wall 15b described above, and the rear end of the front frame 14 is fitted into the recessed portion.

In this way, the front frame 14 is fitted into the recessed portion formed in the rear frame 15, so that the combination of the front frame 14 and the rear frame 15 forms the frame main body 10.

Note that the front frame 14 and the rear frame 15 after the combination may be joined to each other using an adhesive or the like to keep the combined state.

A portion of the rear frame 15 corresponding to the side frame 12 is provided with the back side nipping portion 31 formed in the inner edge wall 15b positioned in the portion.

The back side nipping portion 31 is formed to be capable of being engaged with the front side nipping portion 21 of the front frame 14 to keep the end of the occupant support member 3 in cooperation with the front side nipping portion 21.

In this embodiment, the two back side nipping portions 31 are formed to be spaced apart from each other in the up and down direction on the side corresponding to one side frame 12 (four nipping portions in total being formed on both sides). The back side nipping portions 31 and 31 spaced apart from each other in the vertical direction are coupled together by a flange formed in the portion corresponding to the side frame 12.

The structures and functions of the front side nipping portion 21 and the back side nipping portion 31 will be described later.

Front Side Holing Portion and Rear-Side Holding Portion

Next, a detailed description will be given of the two front-side holding portions 14h and 14h, the two rear-side holding portions 15h and 15h, and their surroundings.

That is, as mentioned above, as shown in FIGS. 3, 6, 8, and the like, the front-side holding portion 14h is formed in the front frame 14 to protrude forward, while protruding upward from the upper end side of a portion corresponding to the upper frame 11.

As shown in FIG. 8, which is a cross-sectional view taken along the line A-A of FIG. 5, the front-side holding portion 14h is formed to have a section with a substantially U shape (that is, in a cup shape with a rectangular bottom).

For convenience of explanation, the upward protruding portion of the front-side holding portion 14h (a portion of the front frame 14 that protrude upward from the upper end side of a portion corresponding to the upper frame 11) is hereinafter referred to as an “upper portion 14h1 of the front-side holding portion”, and a portion of the front frame 14 formed to protrude (upward) toward a portion corresponding to the upper frame 11 is hereinafter referred to as a “lower portion 14h2 of the front-side holding portion” (in particular, see FIG. 5).

The rear-side holding portion 15h protrudes upward from the upper end side of the portion of the rear frame 15 corresponding to the upper frame 11.

The formation position of the rear-side holding portion 15h is set in a position matching with the position of the front-side holding portion 14h (back surface of the front-side holding portion 14h) when the front frame 14 is combined with the rear frame 15.

The rear-side holding portion 15h is formed to have a substantially U-shaped cross section as shown in FIGS. 5, 6, 9, 10, and the like, and the upper portion 14h1 of the front-side holding portion is fitted into the rear-side holding portion 15h.

That is, the rear-side holding portion 15h has the front-side holding portion 14h (upper portion 14h1 of the front-side holding portion) fitted thereinto, while nipping both outer wall portions of the substantially U-shaped side surface of the upper portion 14h1 of the front-side holding portion by both inner walls of the substantially U-shaped side surface.

In short, an opening portion of the upper portion 14h1 of the front-side holding portion is closed with the inner wall of the substantially U-shaped bottom surface of the rear-side holding portion 15h formed in the rear frame 15, and the lower portion 14h2 of the front-side holding portion is closed with a portion corresponding to the upper frame 11 of the rear frame 15.

In this way, the front-side holding portion 14h formed in the front frame 14, and the rear-side holding portion 15h formed in the rear frame 15 (and a portion of the rear frame 15 corresponding to the upper frame 11) form a frame-shaped cylindrical body with a substantially rectangular section (the cylindrical portion being hereinafter referred to as a “guide member attachment portion K”).

The guide member attachment portion K has the headrest guide member G inserted thereinto.

A rear-side engagement hole portion 151a is formed in the rear-side holding portion 15h.

For convenience of explanation, the substantially U-shaped bottom surface of the rear-side holding portion 15h is referred to as a “rear-side bottom portion 150”, the surface of the rear-side holding portion 15h directed inward (each of the opposed surfaces inside both the rear-side holding portions 15h and 15h) is referred to as “rear-side inner surface 151”, and the surface of the rear-side holding portion 15h directed outward is referred to as a “rear-side outer surface 152”) (see FIG. 6).

The rear-side engagement hole portion 151a is formed in the rear-side inner surface 151.

In this embodiment, the rear-side engagement hole portion 151a is formed as a substantially rectangular shaped hole that is made by cutting the rear-side inner surface 151 downward from its upper end side.

The rear-side engagement hole portion 151a communicates with the front-side engagement hole portion 141a in the combined state. The engagement protrusion G21 formed in the headrest guide member G is retained in the communication hole.

In this way, in this embodiment, the rear-side holding portion 15h has the front-side holding portion 14h (upper portion 14h1 of the front-side holding portion) fitted thereinto, while nipping both outer wall portions of the substantially U-shaped side surface of the upper portion 14h1 of the front-side holding portion, by both inner walls of the substantially U-shaped side surface.

Thus, a portion where the rear-side engagement hole portion 151a and the front-side engagement hole portion 141a is formed has a double-walled structure including the rear-side inner surface 151 and the front-side inner surface 141.

Therefore, the rigidity of the vicinity of the rear-side engagement hole portion 151a and the front-side engagement hole portion 141a can be ensured.

However, the structure of the hole portions is not limited thereto. That is, as long as the opening is covered with the rear-side bottom portion 150, the rear-side inner surface 151 and the rear-side outer surface 152 may not be disposed, or only one of these surfaces may be disposed.

Here, the headrest guide member G will be briefly described.

FIG. 6 is an exemplary diagram corresponding to the longitudinal section, and omits the illustration of a structure or the like not directly relating to the present invention.

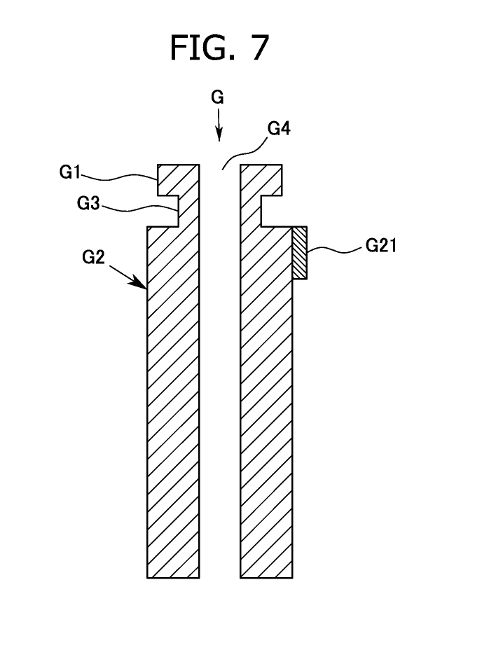

As shown in FIGS. 6 and 7, the headrest guide member G includes a top portion G1 having a substantially prismatic shape, a frame fitted portion G2 having a substantially prismatic shape, and a neck portion G3 coupling these portions.

A pillar shaft through hole G4 is formed to extend and penetrate the center of the guide member G in the longitudinal direction.

An engagement protrusion G21 is provided at an upper end of the surface among the outer surfaces of the frame fitted portion G2 that is directed inward when the frame fitted portion G2 is placed.

The engagement protrusion G21 is formed in a position that matches a communication hole between the front-side engagement hole portion 141a and the rear-side engagement hole portion 151a when the engagement protrusion is placed. Thus, when the headrest guide member G is disposed in the guide member attachment portion K, the engagement protrusion G21 is retained by the communication hole between the front-side engagement hole portion 141a and the rear-side engagement hole portion 151a.

When a peripheral wall of the opening located in a height range of a vertical abutment portion of the headrest guide member G against the headrest pillar HP is formed thickly, the rigidity of a position where a load is applied is improved to further enhance the supporting stability.

When the shape of the abutment portion is formed along the shape of the headrest pillar HP, the load can be received not by points, but by being diffused.

Further, the peripheral wall of the opening of the headrest guide member G is preferably formed more thickly in the front to back direction than in the right and left direction.

With this arrangement, the rigidity of the position where the load from the headrest pillar HP is most likely to be transferred is improved to further enhance the supporting stability.

The front-side holding portion 14h and the headrest guide member G may be integrally formed together to become an integrated holder.

With this arrangement, the front-side holding portion 14h and the headrest guide member G do not need to be separately formed, which reduces the number of components of the structure and also improves its rigidity.

In this embodiment, a rear frame hole portion 15i in the rear frame 15 is formed above a position corresponding to the hole RH and below a position corresponding to the upper frame 11 (see FIGS. 2, 3, 5, and 11, and the like).

The periphery of the rear frame 15 is bent toward the front side to form a flange 15j.

With this structure, the rigidity of the rear frame 15 (especially, in the vicinity of the rear frame hole portion 15j) is improved. The guide attachment portions K and K are disposed in the rear frame 15 with improved rigidity, thereby enabling stable support of the headrest S3.

The flange 15j (particularly, a portion formed above) is formed in a position that does not interfere with the headrest guide member G.

That is, the flange 15j is formed to be positioned under a lower end portion of the headrest guide member G when the headrest guide member G is disposed.

Thus, this embodiment can effectively prevent the interference of the headrest guide member G with the flange 15j.

The flange 15j (particularly, a portion formed above) is formed between the guide member attachment portions K and K.

Thus, the rigidity of the portion between the guide member attachment portions K and K is improved, and the guide attachment portions K and K are disposed at the rear frame 15 with the improved rigidity, so that the headrest S3 can be more stably supported.

Although in this embodiment, the flange 15j is formed at the rear frame 15, the flange portion is not limited thereto. Alternatively, a structure corresponding to the front-side holding portion 14h may be formed in the rear frame 15, and another structure corresponding to the flange 15j may be formed on a side of the front frame 14.

That is, the structure corresponding to the flange 15j can be formed at a side different from the side at which the structure corresponding to the front-side holding portion 14h is formed.

A flange bending and protruding forward from the upper side of the hole RH is provided to improve the rigidity of the structure. The flange protruding forward from the upper side of the hole RH protrudes forward with respect to the flange 15j.

Further, other flanges are also respectively provided in positions corresponding to the upper parts of the side frames 12 and 12 of the front frame 14. These flanges each include a portion along the hole RH, a portion along the rear frame hole portion 15i, and a portion coupling these parts.

The upper end of the flange is configured to extend toward the rear frame hole portion 15i.

With this arrangement, the rigidity of the surroundings of the hole RH and rear frame hole portion 15i can be enhanced.

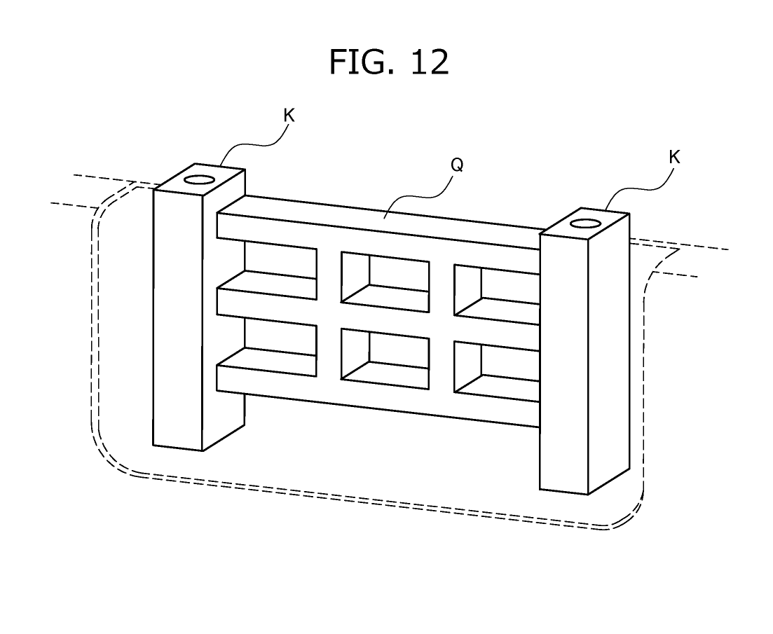

A modified example will be described with reference to FIG. 12.

In this embodiment, the guide member attachment portions K and K are coupled together.

That is, a rib member Q having a matrix shape bridges and couples the guide member attachment portions K and K.

This can further improve the rigidity and strength of the vehicle seat structure.

The shape of the member for coupling is not limited thereto, and any shape can be used without departing from the scope of the present invention.

Front-Side Nipping Portion 21 and Rear-Side Nipping Portion 31

Next, the structure and function of the front side nipping portion 21 and the back side nipping portion 31 will be described in detail below with reference to FIGS. 3 and 4, FIGS. 13 to 21, and the like.

The occupant support member 3 is attached to the frame main body 10 in a state of extending along the width direction while meandering in the up and down direction as mentioned above. In particular, in this embodiment, the occupant support member 3 is disposed in a hole RH having a substantially square shape and surrounded by the upper frame 11, side frames 12, and lower frame 13 of the frame main body 10. The occupant support member 3 supports the occupant sitting on the vehicle seat S from the back of the occupant during the normal time, while being deformed such that the occupant sinks rearward when the vehicle receives the rear impact and load. In this way, the deformation of the occupant support member 3 relieves the influence of the rear impact and load on the occupant.

In this embodiment, two occupant support members 3 are disposed in the above-mentioned hole RH while being spaced apart from each other in the up and down direction. Note that the presence of at least one of the occupant support members 3 is sufficient, but the number of the occupant support members 3 can be arbitrarily set.

In this embodiment, the occupant support member 3 is disposed in the above-mentioned hole RH by attaching both ends in the width direction of the occupant support member 3 to attachment parts formed in the respective side frames 12. More specifically, the occupant support member 3 is laid from one side frame 12 to the other side frame 12 along the width direction. By this procedure, the occupant support member 3 is arranged between the side frames 12. In the arrangement position, the occupant support member 3 extends in the width direction, while meandering in the up and down direction.

On the other hand, in this embodiment, a portion of each side frame 12 of the frame main body 10 is provided with the attachment portion for the occupant support member 3. The attachment portion is integrally formed by the CFRP with other parts of the side frame 12.

As described above, in the structure that includes the attachment portion of the occupant support member 3 formed by processing a portion of the frame main body 10 made of CFRP, it is necessary to ensure the rigidity of the attachment portion itself of the frame main body 10 in order to appropriately attach the occupant support member 3 to the frame main body 10.

Thus, in this embodiment, the portion of the frame main body 10 with a relatively high rigidity is used as the attachment portion of the occupant support member 3. As a result, the attachment state of the occupant support member 3 to the frame main body 10 can be kept good.

As mentioned above, the parts corresponding to the side frames 12 in the front frame 14 are provided with front side nipping portions 21 formed at the inner surfaces 14b of the parts. The front side nipping portion 21 holds the end of the occupant support member 3 in cooperation with the back side nipping portion 31 to be described later. Thus, the occupant support member 3 is attached to the frame main body 10. Note that the inner surface 14b with the front side nipping portion 21 formed therein corresponds to the end of the front frame 14 in the width direction.

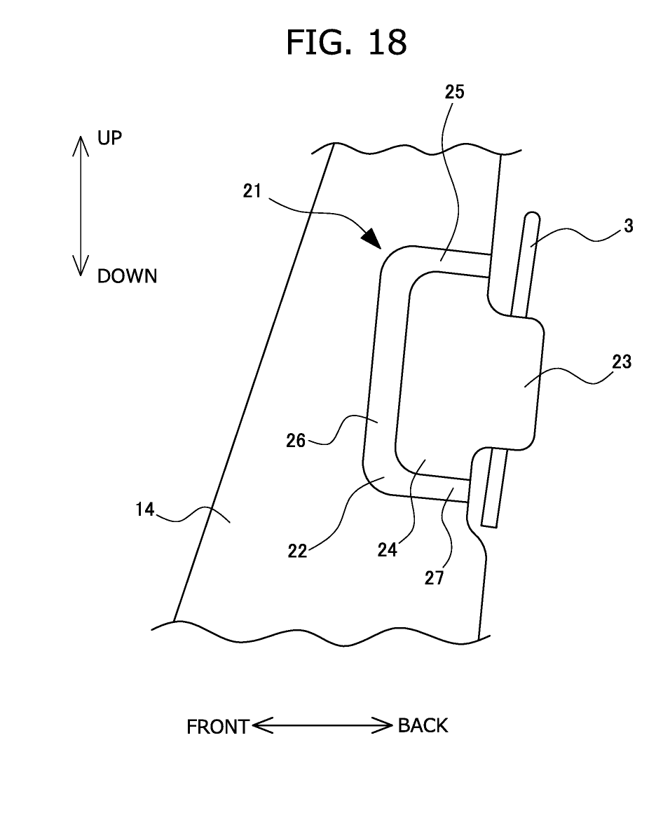

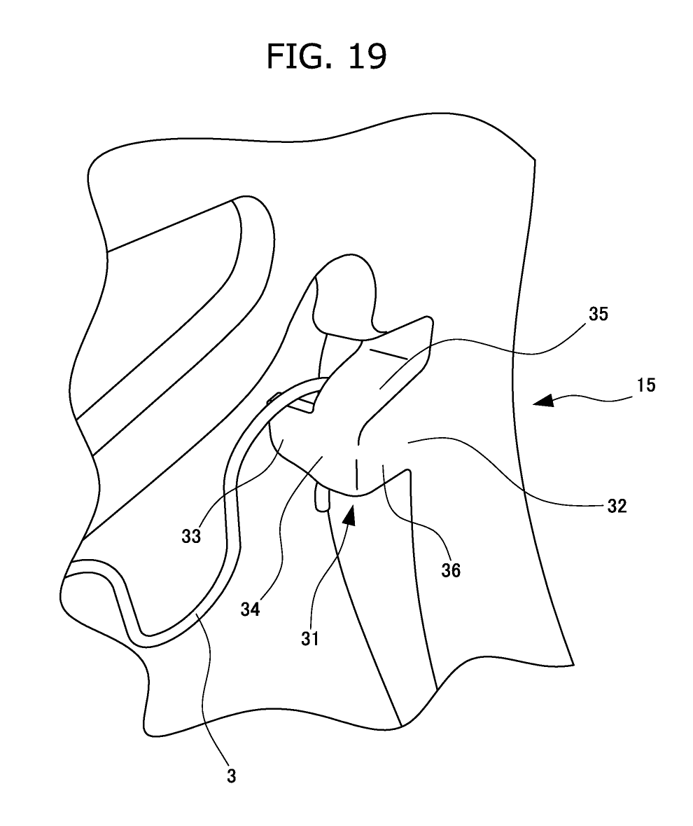

Now, the front side nipping portion 21 is described in detail. As shown in FIGS. 17 and 18, the front side nipping portion 21 includes a front side convex portion 22 protruding inward from the inner surface 14b in the width direction. The front side convex portion 22 is formed by raising a predetermined region of the portion of the front frame 14 corresponding to the side frame 12, inward in the width direction in a substantially rectangular parallelepiped shape. The front side convex portion 22 has a top surface 24 positioned at the most inner side in the width direction. The top surface 24 is a flat surface with the width direction being set as its normal direction.

Further, the front side convex portion 22 has three adjacent surfaces that are adjacent to the top surface 24. Specifically, the convex portion 22 includes an upper surface 25 positioned on the uppermost side, a front surface 26 positioned on the front most side, and a lower surface 27 positioned on the lowermost side. The rear end of the front side convex portion 22 is an opening end.

In this embodiment, each of the upper surface 25, front surface 26, and lower surface 27 is an inclined surface. Specifically, as the upper surface 25 approaches the top surface 24, that is, extends toward the inner side in the width direction, the upper surface 25 is inclined to be positioned at the lower side. As the front surface 26 approaches the top surface 24, that is, extends toward the inner side in the width direction, the front surface 26 is inclined to be positioned at the rear side. As the lower surface 27 approaches the top surface 24, that is, extends in the width direction, the lower surface 27 is inclined to be positioned at the upper side. As shown in FIG. 18, in each of the upper surface 25, front surface 26, and lower surface 27, the end adjacent to the top surface 24 is bent in an arc shape.

As shown in FIGS. 17 and 18, the front side nipping portion 21 is provided with a tongue-shaped protrusion 23 that protrudes rearward from a wall surface positioned at the rear end of the front side convex portion 22, specifically, a wall surface adjacent to the top surface 24. The tongue-shaped protrusion 23 serves as a movement restriction portion in this embodiment to be described later.

In this embodiment, the tongue-shaped protrusion 23 serving as the movement restriction portion formed in the front side nipping portion 21 has its upper and lower ends positioned between the upper and lower ends of the top surface 24 of the front side convex portion 22 in the up and down direction. More specifically, the tongue-shaped protrusion 23 extends rearward from a region positioned at the substantially center in the up and down direction of the rear end wall surface of the front side convex portion 22.

In this embodiment described above, the movement restriction portion formed in the front side nipping portion 21 is accommodated between the upper and lower ends of the front side convex portion 22 in the up and down direction, strictly speaking, between the upper end and lower end of the top surface 24, which can suppress the increase in size of the seatback frame 1, specifically, the expansion of the seatback frame 1 in the up and down direction.

As shown in FIG. 3, in this embodiment, the two front side nipping portions 21 are provided side by side in the up and down direction at a portion corresponding to the respective side frames 12. That is, in this embodiment, two pairs of front side nipping portions 21, the nipping portions of each pair being opposed to each other in the width direction, that is, the four front side nipping portions 21 are provided in the front frame 14.

Further, as shown in FIG. 18, the front side convex portion 22 included in each front side nipping portion 21 protrudes from a region positioned on the rear end side of the inner surface 14b, more specifically, from a region positioned on the rear side rather than the center of the inner surface 14b in the front to back direction.

The parts corresponding to the side frames 12 in the rear frame 15 are provided with the back side nipping portions 31 formed at the inner edge walls 15b positioned at the parts. The back side nipping portion 31 is formed to be engaged with the front side nipping portion 21 of the front frame 14, and holds the ends of the occupant support member 3 in cooperation with the front side nipping portion 21. Note that the inner edge wall 15b with the back side nipping portion 31 formed therein corresponds to the end of the rear frame 15 in the width direction.

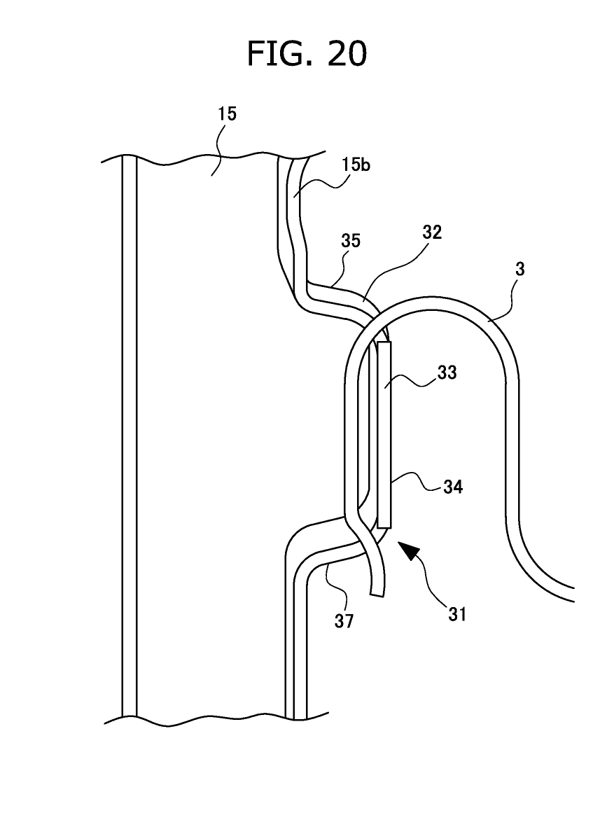

Now, the back side nipping portion 31 will be described in detail. As shown in FIGS. 19 and 20, the back side nipping portion 31 includes a back side convex portion 32 formed by bulging the inner edge wall 15b inward in the width direction. The back side convex portion 32 is formed by raising a predetermined region of a portion of the rear frame 15 corresponding to the side frame 12 inward in the width direction in a substantially rectangular parallelepiped shape. The back side convex portion 32 has a top surface 34 positioned at the most inner side in the width direction. The top surface 34 is a flat surface with the width direction being set as its normal direction.

The back side convex portion 32 has three adjacent surfaces that are adjacent to the top surface 34. Specifically, the convex portion 32 includes an upper surface 35 positioned on the uppermost side, a rear surface 36 positioned on the rearmost side, and a lower surface 37 positioned on the lowermost side. The front end of the back side convex portion 32 is an opening end.

In this embodiment, each of the upper surface 35, rear surface 36, and lower surface 37 is an inclined surface. Specifically, as the upper surface 35 approaches the top surface 34, that is, extends toward the inner side in the width direction, the upper surface 35 is inclined to be positioned at the lower side. As the rear surface 36 approaches the top surface 34, that is, extends toward the inner side in the width direction, the rear surface 36 is inclined to be positioned at the front side. As the lower surface 37 approaches the top surface 34, that is, extends along the width direction, the lower surface 37 is inclined to be positioned at the upper side. As shown in FIGS. 19 and 20, in each of the upper surface 35, rear surface 36, and lower surface 37, the end adjacent to the top surface 34 is bent in an arc shape.

As shown in FIGS. 19 and 20, the back side nipping portion 31 is provided with a tongue-shaped protrusion 33 that protrudes forward from a wall surface positioned at the front end of the back side convex portion 32, specifically, a wall surface adjacent to the top surface 34. The tongue-shaped protrusion 33 serves as a movement restriction portion in this embodiment to be described later.

In this embodiment, the tongue-shaped protrusion 33 serving as the movement restriction portion formed in the back side nipping portion 31 has its upper and lower ends positioned between the upper and lower ends of the top surface 34 of the back side convex portion 32 in the up and down direction. More specifically, the tongue-shaped protrusion 33 extends forward from a region positioned at the substantially center in the up and down direction of the front end wall surface of the back side convex portion 32.

In this embodiment described above, the tongue-shaped protrusion 33 formed in the back side nipping portion 31 is accommodated between the upper and lower ends of the back side convex portion 32 in the up and down direction, strictly speaking, between the upper end and lower end of the top surface 34, which can suppress the increase in size of the seatback frame 1, specifically, the expansion of the seatback frame 1 in the up and down direction.

As shown in FIG. 4, in this embodiment, the two back side nipping portions 31 are provided side by side in the up and down direction at parts corresponding to the respective side frames 12. That is, in this embodiment, two sets of pairs of back side nipping portions 31, the nipping portions of each pair being opposed to each other in the width direction, that is, the four back side nipping portions 31 are provided in the rear frame 15.

Further, as shown in FIG. 20, the back side convex portion 32 included in each back side nipping portion 31 protrudes from a region positioned on the rear end side in the portion corresponding to the side frame 12 of the rear frame 15, more specifically, from a region positioned on the rear side rather than the center of the portion corresponding to the side frame 12 in the front to back direction.

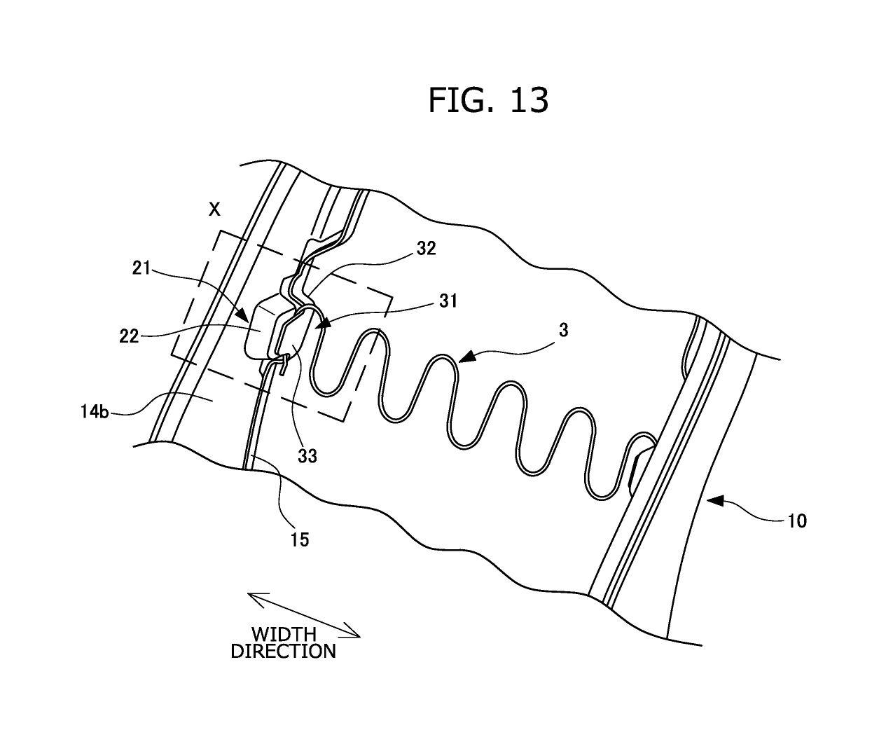

By combining the front frame 14 and the rear frame 15, each front side nipping portion 21 is engaged with the corresponding back side nipping portion 31. In other words, each front side nipping portion 21 is engaged with the corresponding back side nipping portion 31, thereby forming the frame main body 10. Here, the sentence “the front side nipping portion 21 is engaged with the back side nipping portion 31”, as shown in FIGS. 13, 14, and 21, means that the front side nipping portion 21 and the back side nipping portion 31 are adjacent to each other in the front to back direction, and combined together to be overlapped to each other in the width direction.

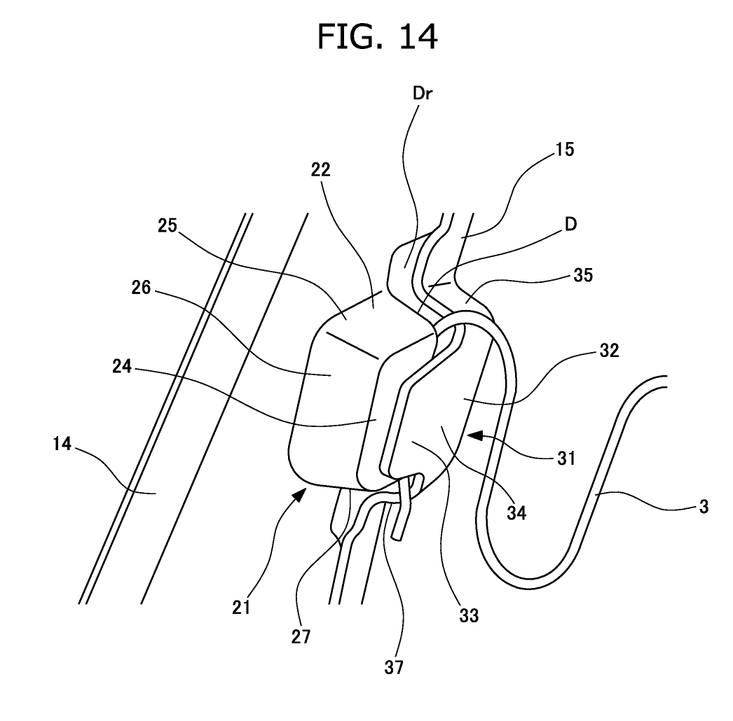

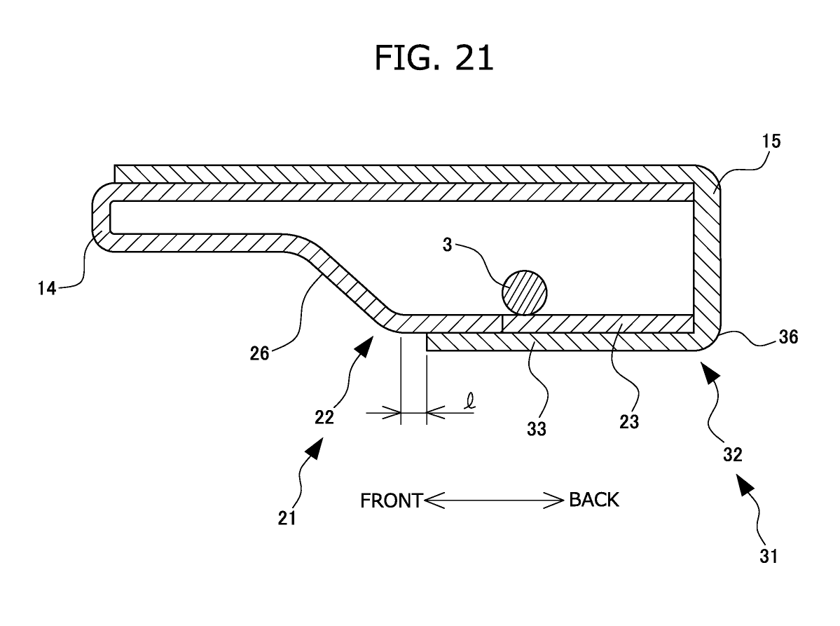

Now, the engagement state between the front side nipping portion 21 and the back side nipping portion 31 will be described in more detail. When viewing the front side nipping portion 21 and the back side nipping portion 31 in the engagement state from the front surface side, as shown in FIG. 3, the front side nipping portion 21 is inserted into a space enclosed by the inner edge wall 15b configuring the back side convex portion 32. As shown in FIGS. 14 and 21, the tongue-shaped protrusion 23 of the front side nipping portion 21 and the tongue-shaped protrusion 33 of the back side nipping portion 31 are adjacent to each other in the width direction, and arranged opposed to each other. In this embodiment, while the front side nipping portion 21 and the back side nipping portion 31 are engaged together, the tongue-shaped protrusion 33 formed in the back side nipping portion 31 is positioned at the inner side in the width direction of the tongue-shaped protrusion 23 formed in the front side nipping portion 21.

Further, as shown in FIGS. 13, 14, and 21, while the front side nipping portion 21 and the back side nipping portion 31 are engaged together, the tongue-shaped protrusions 23 and 33 formed in the respective nipping portions 21 and 31 reach the convex portion 22 and 32 of the paired nipping portions 21 and 31 in the front to back direction. Specifically, while the front side nipping portion 21 is engaged with the back side nipping portion 31, the tongue-shaped protrusion 23 formed in the front side nipping portion 21 extends from the rear end of the front side convex portion 22 to the rear side with respect to the front end of the back side convex portion 32. On the other hand, the tongue-shaped protrusion 33 formed in the back side nipping portion 31 extends from the front end of the back side convex portion 32 to the front side with respect to the rear end of the front side convex portion 22.

As shown in FIGS. 14 to 16, while the front side nipping portion 21 and the back side nipping portion 31 are engaged with each other, there occurs a gap D between the rear end of the front side convex portion 22 and the front end of the back side convex portion 32. When the end of the occupant support member 3 is inserted into the gap D, the occupant support member 3 is nipped between the front side nipping portion 21 and the back side nipping portion 31. In this way, in this embodiment, the occupant support member 3 is nipped between the front side nipping portion 21 and the back side nipping portion 31, and as a result, the occupant support member 3 is attached to the frame main body 10.

As mentioned above, in the seatback frame 1 according to this embodiment, the occupant support member 3 is attached to the frame main body 10 by being nipped between the front frame 14 and the rear frame 15. The parts of the front frame 14 and the rear frame 15 that nip the occupant support member 3 therebetween are engaged with each other in combination so that the rigidity of the combined structure becomes relatively high. Thus, in this embodiment, the rigidity of the attachment portion of the frame main body 10 made of the CFRP to the occupant support member 3 can be ensured.

In this embodiment, the parts of the front frame 14 and the rear frame 15 that nip the occupant support member 3 therebetween, that is, the front side convex portion 22 and the back side convex portion 32 are formed to protrude from the end in the width direction of each of the front frame 14 and the rear frame 15 to the inner side in the width direction. The use of such a structure suppresses the increase in size of the seatback frame 1, especially, the expansion thereof toward the outside in the width direction, as compared to a structure in which the parts nipping the occupant support member 3 are provided outside the front frame 14 and the rear frame 14 in the width direction.

In this embodiment, as described above, the front side convex portion 22 provided in each front side nipping portion 21 protrudes from a region positioned on the rear end side of the ends in the width direction of the front frame 14. Likewise, the back side convex portion 32 included in each back side nipping portion 31 protrudes from the region positioned on the rear end side of the ends in the width direction of the rear frame 15. As mentioned above, the front side convex portion 22 and the back side convex portion 32 are arranged to be positioned on the rear side in the front to back direction so that the occupant support member 3 nipped between the front side nipping portion 21 and the back side nipping portion 31 is positioned on the rear side. On the other hand, as the occupant support member 3 is positioned on the more rear side, the rear impact and load is applied more on the vehicle, which can ensure a larger amount of sinking in the rear direction of the occupant sitting on the vehicle seat S. Thus, in the vehicle seat S according to this embodiment, the use of the structure described above appropriately ensures the amount of sinking of the occupant.

In this embodiment, as shown in FIG. 14, the above-mentioned gap D is formed long along the width direction. Specifically, the opening provided in the gap D, and into which the end of the occupant support member 3 is inserted is formed to be long in the width direction. In more detail, the opening of the above-mentioned gap D has a length corresponding to the protruding amount of each of the convex portion 22 and 32 included in the respective nipping portions 21 and 31. In this way, the insertion port of the occupant support member 3 is formed long along the width direction, which allows the occupant support member 3 to be easily inserted into the gap D, thereby improving the assemble properties of the occupant support member 3.

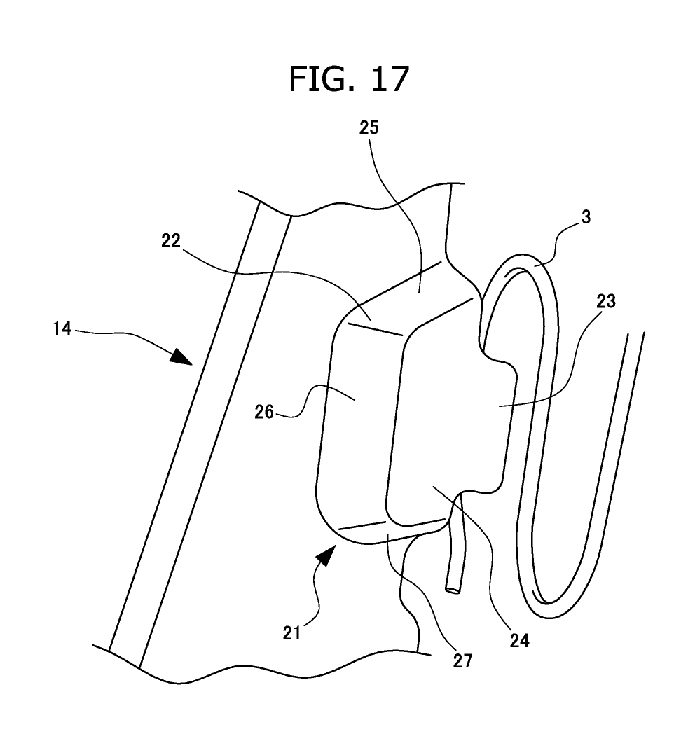

The combination of the front frame 14 and the rear frame 15 forms the frame main body 10, so that the region of the side frame 12 of the frame main body 10 adjacent to the above-mentioned gap D is provided with an elongated adjacent hole Dr shown in FIGS. 14 and 16. The adjacent hole Dr is formed at the inner surface in the width direction of the side frame 12, and has a slight length along the up and down direction. In this way, the adjacent hole Dr is provided to continuously lead to the gap D formed between the front side convex portion 22 and the back side convex portion 32, which facilitates the insertion of the occupant support member 3 into the gap D, thereby improving the assembly properties of the occupant support member 3.

Further, in this embodiment, while the occupant support member 3 is attached to the frame main body 10, the upper end of the adjacent hole Dr is positioned above the upper end of the occupant support member 3. The term “upper end of the occupant support member 3” as used herein means the position of an upper end where the occupant support member 3 reaches while meandering in the up and down direction. In this way, since the upper end of the adjacent hole Dr is positioned above the upper end of the occupant support member 3, the occupant support member 3 is more easily inserted into the gap D, which improves the assembly properties of the occupant support member 3.

Further, in this embodiment as mentioned above, the upper surface 25 of the front side convex portion 22 and the upper surface 35 of the back side convex portion 32 are inclined surfaces that are inclined to be positioned at the lower level toward the inner side in the width direction. In this way, the respective upper surface 25 and 35 are inclined, which makes it easy to recognize the respective upper surfaces 25 and 35, thereby enabling easy identification of the positions of the upper surface 25 and 35 when the occupant support member 3 is nipped between the front side and back side convex portions 22 and 32. For better understanding, when the end of the occupant support member 3 is inserted into the gap D between the front side and back side convex portions 22 and 32, the position of the opening of the gap D can be easily recognized. As the respective upper surface 25 and 35 are inclined to be positioned at the lower level toward the inner side in the width direction, the occupant support member 3 can be suppressed from interfering with the upper surfaces 25 and 35 when the end of the occupant support member 3 is inserted into the gap D. In this way, the respective upper surface 25 and 35 are inclined, thereby improving the workability in attaching the occupant support member 3.

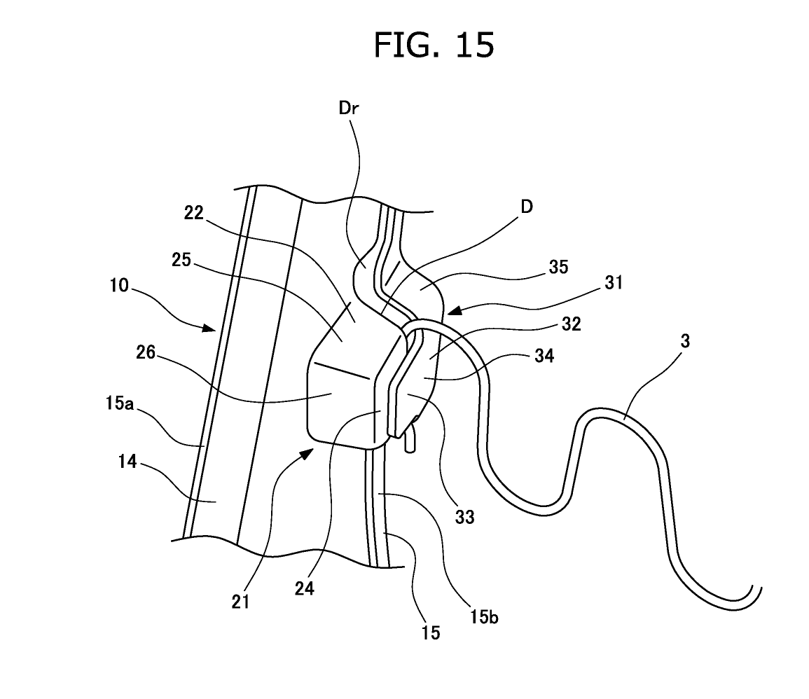

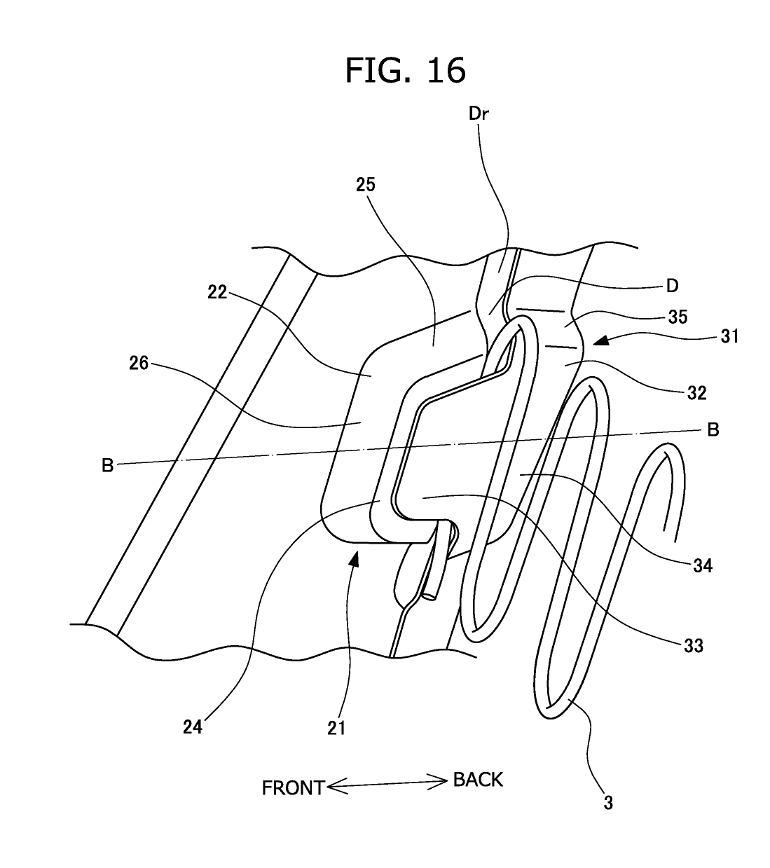

When the end of the occupant support member 3 is inserted into the gap D between the front side convex portion 22 and the back side convex portion 32, as shown in FIGS. 15 and 21, the tongue-shaped protrusions 23 and 33 formed in the respective nipping portions 21 and 31 are arranged adjacent to the end of the occupant support member 3 in the width direction that is inserted into the gap D. In this way, even though the end of the occupant support member 3 is intended to move toward the inner side in the width direction, the end is retained by the tongue-shaped protrusions 23 and 33, whereby the movement of the occupant support member 3 in the same direction is restricted. As a result, the occupant support member 3 is maintained in the position where the support member 3 is nipped between the front side nipping portion 21 and the back side nipping portion 31.

As mentioned above, in this embodiment, the tongue-shaped protrusion 23 and 33 formed in the nipping portions 21 and 31, respectively, serve as the movement restriction portion for restricting the movement of the occupant support member 3 from the position where the support member is nipped between the front and back side nipping portions 21 and 31 toward the inner side in the width direction. In this way, the provision of the tongue-shaped protrusions 23 and 33 as the movement restriction portion can stably hold the occupant support member 3 in the attachment position of the frame main body 10.

In particular, in this embodiment, as mentioned above, when the front and back side nipping portions 21 and 31 are engaged with each other, the tongue-shaped protrusions 23 and 33 formed in the respective nipping portions 21 and 31 are arranged adjacent to each other in the width direction and in positions opposed to each other. That is, in this embodiment, the two tongue-shaped protrusions 23 and 33 are superimposed on each other in the width direction. Thus, the tongue-shaped protrusions 23 and 33 are superimposed as the movement restriction portion, which can more effectively restrict the movement of the occupant support member 3 from the position where the support member 3 is nipped between the front and back side nipping portions 21 and 31 toward the inner side in the width direction.

Further, in this embodiment, as mentioned above, while the front and back side nipping portions 21 and 31 are being engaged with each other, the tongue-shaped protrusion 23 formed in the front side nipping portion 21 extends from the rear end of the front side convex portion 22 and is elongated to the rear side with respect to the front end of the back side convex portion 32. The tongue-shaped protrusion 33 formed in the back side nipping portion 31 extends from the front end of the back side convex portion 32 and is elongated to the forward side with respect to the rear end of the front side convex portion 32. With this arrangement, the occupant support member 3 is placed to be nipped between the front side nipping portion 21 and the back side nipping portion 31, while being restricted by the tongue-shaped protrusions 23 and 33 as the movement restriction portion. As a result, in this embodiment, the attachment state of the occupant support member 3 with respect to the frame main body 10 can be stably maintained.

In this embodiment, as shown in FIG. 21, while the front side nipping portion 21 and the back side nipping portion 31 are being engaged with each other, the tongue-shaped protrusion 33 formed in the back side nipping portion 31 is positioned on the inner side in the width direction rather than the tongue-shaped protrusion 23 formed in the front side nipping portion 21. By using such a positional relationship, this embodiment can ensure a larger amount of sinking when the passenger sitting on the vehicle seat S sinks rearward due to the rear impact and load on the vehicle.

More specifically, the nipping portions 21 and 31 are engaged with each other such that the tongue-shaped protrusion 33 formed in the back side nipping portion 31 is positioned on the inner side in the width direction rather than the tongue-shaped protrusion 23 formed in the front side nipping portion 21. In this case, as shown in FIG. 21, the front end position of the tongue-shaped protrusion 33 formed in the back side nipping portion 31 is positioned on the rear side rather than the front end position of the front side nipping portion 21 (specifically, the front surface 26 of the front side nipping portion 21) by a distance represented by a reference character I. Thus, a stepped portion is formed by the distance I between the front end of the front side nipping portion 21 and the front end of the tongue-like protrusion 33 formed in the rear side nipping portion 31. By the distance I, a space for the occupant to sink rearward is expanded. As a result, a greater amount of sinking for the occupant can be ensured.

Further, in this embodiment, while the occupant support member 3 is attached to the frame main body 10, the upper and lower ends of the tongue-shaped protrusions 23 and 33 formed in the front side nipping portion 21 and the back side nipping portion 31, respectively, are positioned between the upper and lower ends of the occupant support member 3 in the up and down direction. Here, the term “upper end of the occupant support member 3” as used herein means the position of an upper end where the occupant support member 3 reaches while meandering vertically. Likewise, the term “lower end of the occupant support member 3” as used herein means the position of a lower end where the occupant support member 3 reaches while meandering. In such a positional relationship, the tongue-shaped protrusions 23 and 33 serving as the movement restriction portion are accommodated in the up and down direction in a range where the occupant support member exists. Thus, this embodiment can more effectively suppress the increase in size of the seatback frame 1 in the up and down direction.

The embodiments described above are intended to make the understanding of the present invention easier by way of example, but are not intended to limit the present invention. That is, it is apparent that the shape, dimension, arrangement, and the like of the seatback frame 1 in the above-mentioned embodiments can be changed and modified without departing from the scope of the present invention, and thus the present invention can include the equivalent thereto.

Although in the above-mentioned embodiments, the front side nipping portion 21 and the back side nipping portion 31 are provided with the tongue-shaped protrusions 23 and 33 as the movement restriction portion, respectively, the invention is not limited thereto. At least one of the front side nipping portion 21 and the back side nipping portion 31 may be provided with the movement restriction portion. That is, only the front side nipping portion 21, or only the back side nipping portion 31 may be provided with the movement restriction portion. Note that the movement restriction portions are desirably formed in the respective front and back side nipping portions 21 and 31 from the viewpoint of effectively suppressing the movement of the occupant support member 3 from the position where the occupant support member 3 is nipped between the front side nipping portion 21 and the back side nipping portion 31, toward the inner side in the width direction.

In the above-mentioned embodiment, the front side convex portion 22 included in the front side nipping portion 21, and the back side convex portion 32 included in the back side nipping portion 31 include top surfaces 24 and 34, and three surfaces adjacent to the top surfaces 24 and 34, respectively. In the above-mentioned embodiment, the adjacent surfaces included in the respective front and back side nipping portions 21 and 31 are all inclined surfaces. However, the present invention is not limited thereto. Alternatively, only the upper surfaces 25 and 35 of the three adjacent surfaces may be an inclined surface. Further, the upper surface 25 or 35 included in at least one of the front side convex portion 22 and the back side convex portion 32 may be an inclined surface. That is, only the upper surface 25 of the front side convex portion 22, or only the upper surface 35 of the back side convex portion 32 may be the inclined surface.

The above-mentioned embodiments have described the occupant support member 3 made of a spring meandering in the up and down direction. However, as long as a member constituting the occupant support member 3 can be deformed to allow the occupant sitting on the vehicle seat S to sink rearward, the member may be used for the occupant support member 3. For example, an elastic plate having a width in the up and down direction may constitute the occupant support member 3.

In the above embodiment, the portion of the frame main body 10 that nips the occupant support member 3 is formed in the side frame 12. In particular, in this embodiment, the portion for nipping the occupant support member 3 toward the inner side in the width direction of the side frame 12, that is, the front side nipping portion 21 and the back side nipping portion 31 are provided for the viewpoint of suppressing the increase in size of the seatback frame 1. Note that the present invention is not limited thereto, and alternatively, the portion nipping the occupant support member 3 may be provided outside the side frame 12 in the width direction. The portion nipping the occupant support member 3 may be provided in a portion of the frame main body 10, other than the side frame 12, for example, the upper frame 11 or the lower frame 13.

### Second Embodiment

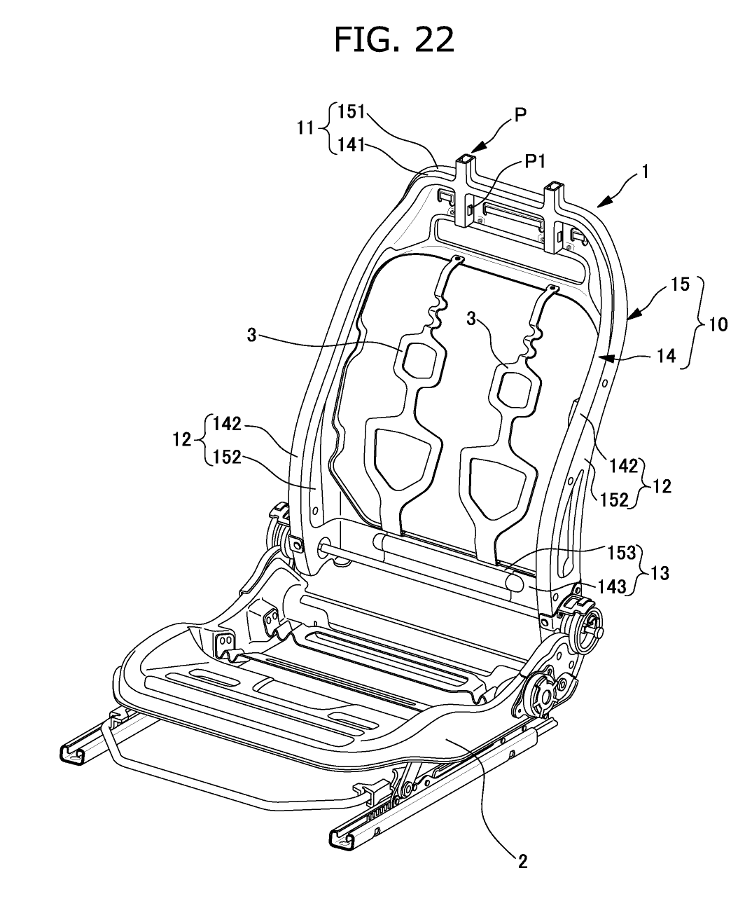

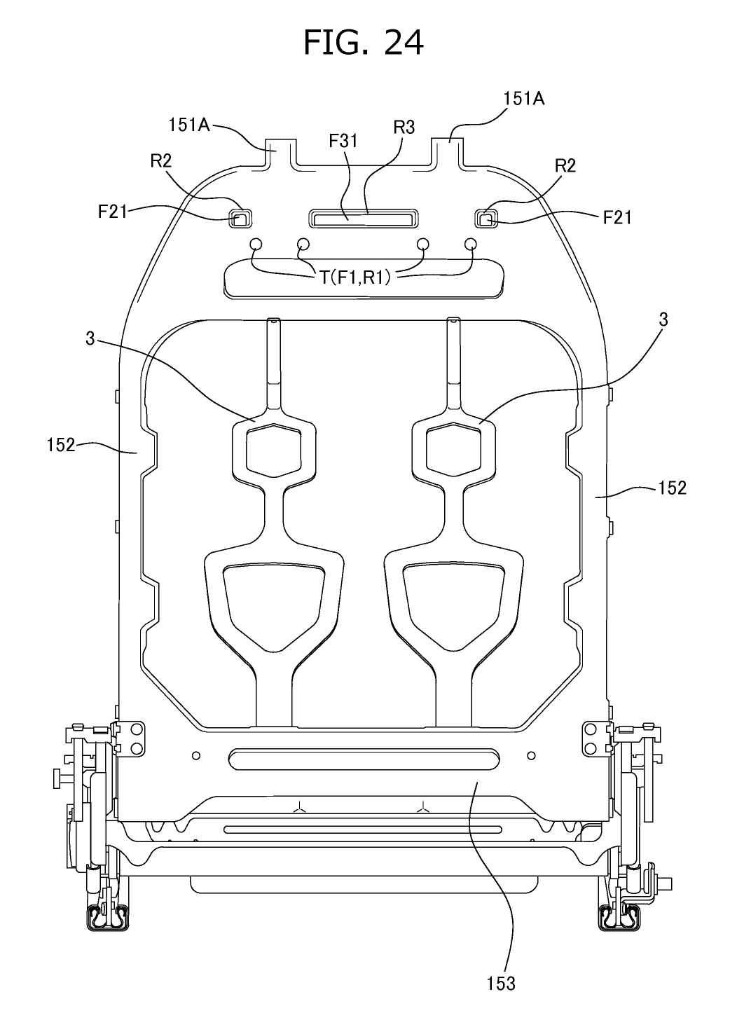

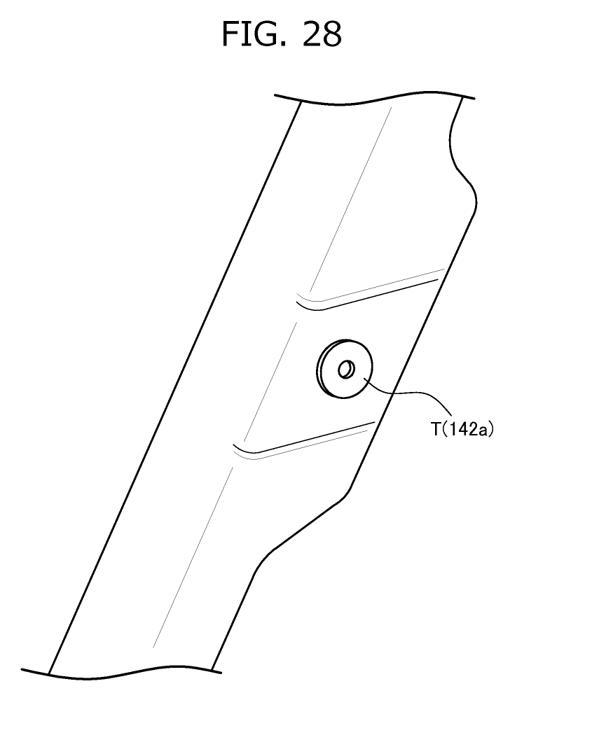

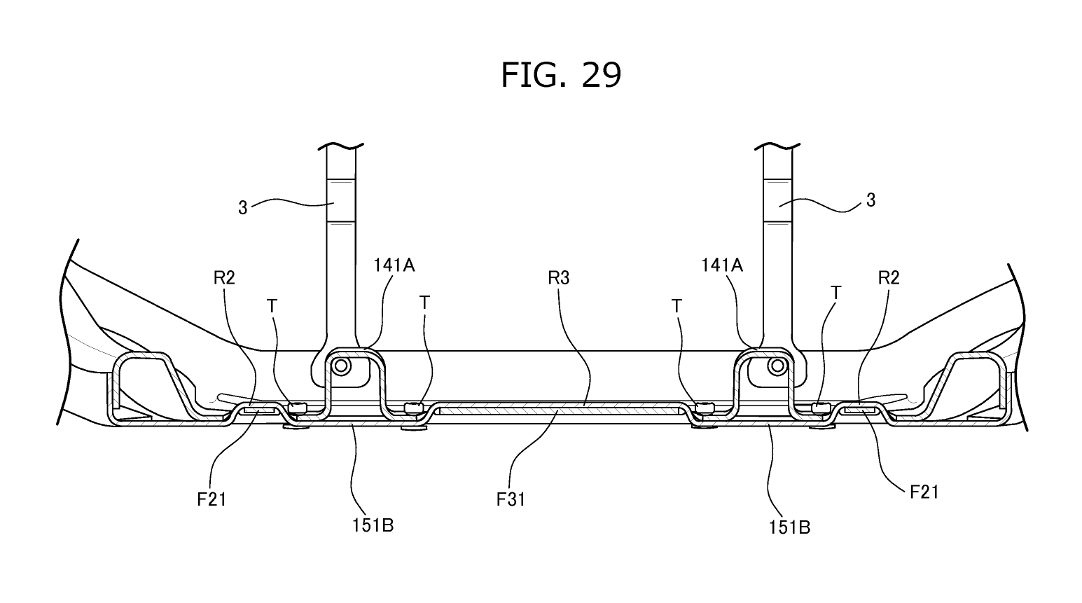

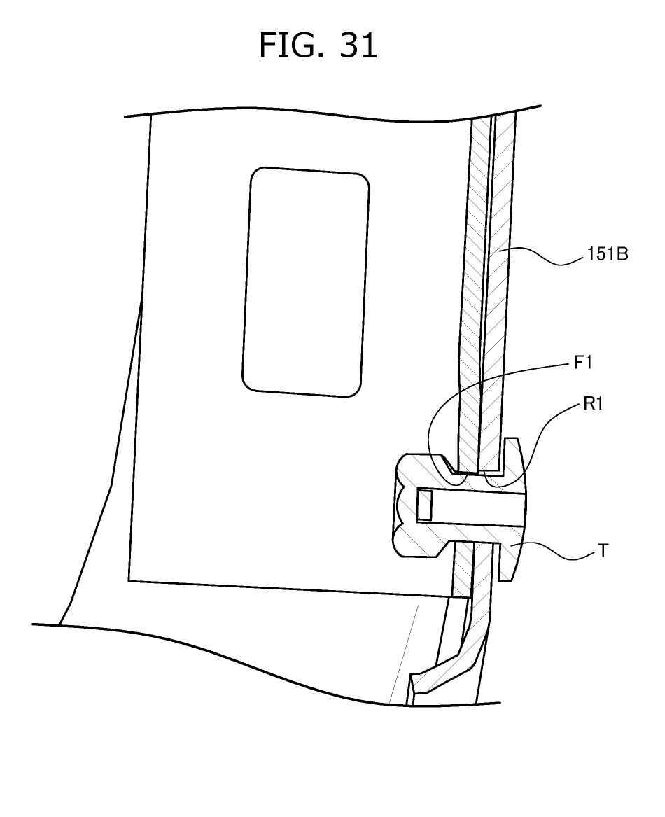

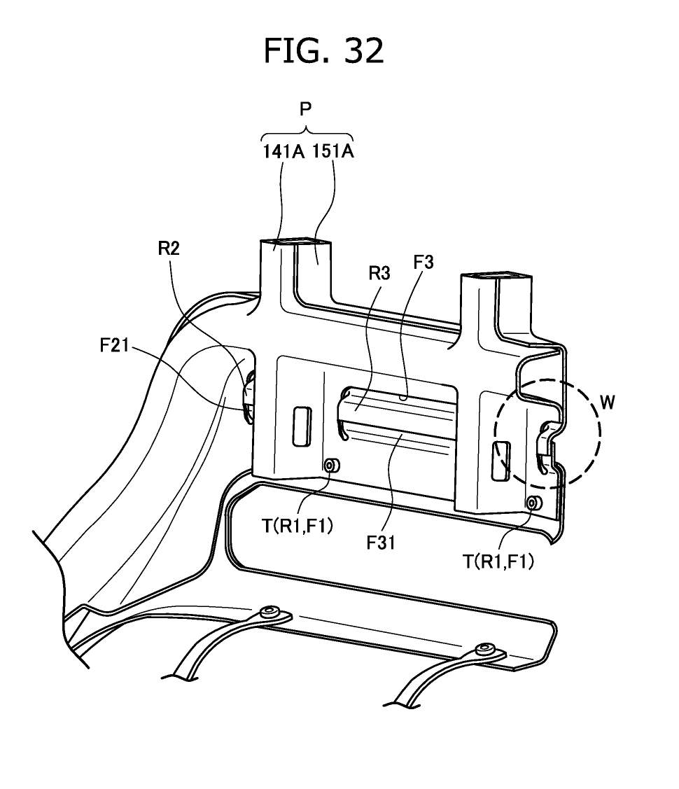

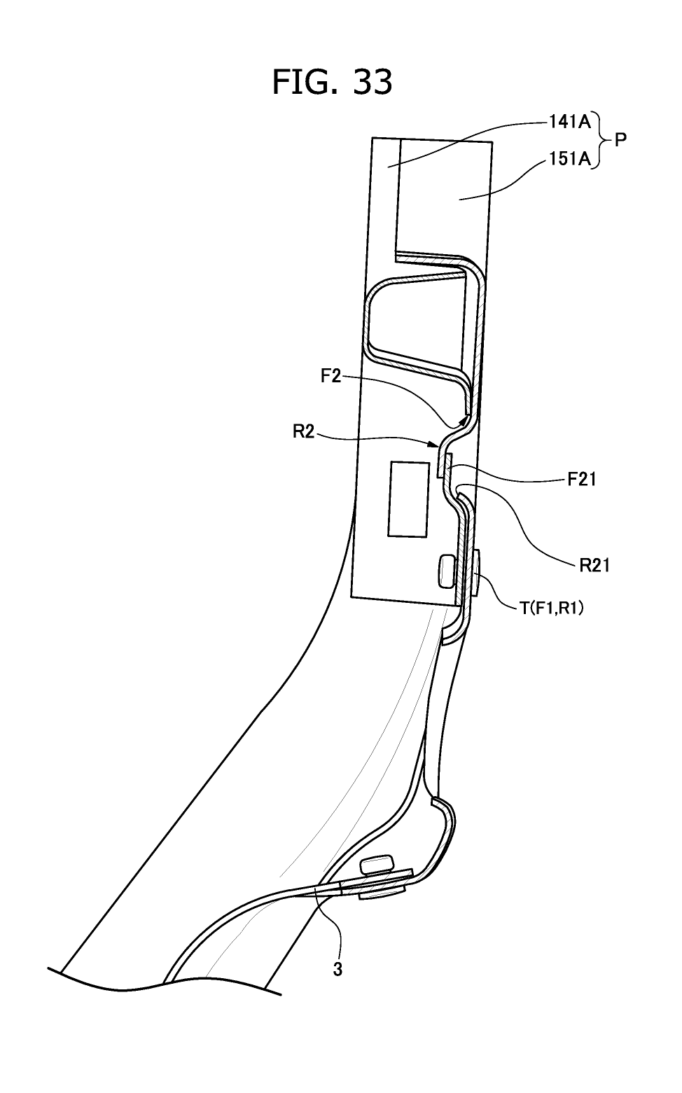

Next, a second embodiment of the present invention will be described below with reference to FIGS. 22 to 33.

In this example, the front frame 14 and the rear frame 15 are easily assembled with the high rigidity.

A seatback frame 1 that is a little bit different type from that of the first embodiment is exemplified, but has substantially the same structure. A structure for assembly in the present embodiment is applied to the seatback frame 1 according to the above-mentioned first embodiment, and thus can achieve the high assembly workability, while maintaining the high rigidity in addition to the above operation and effects.

Note that the same structure is denoted by the same reference character, and a description thereof will be omitted.

Structure of Frame Main Body

Like the above-mentioned first embodiment, the frame main body 10 is formed by combining the front frame 14 and the rear frame 15 (see FIG. 2).

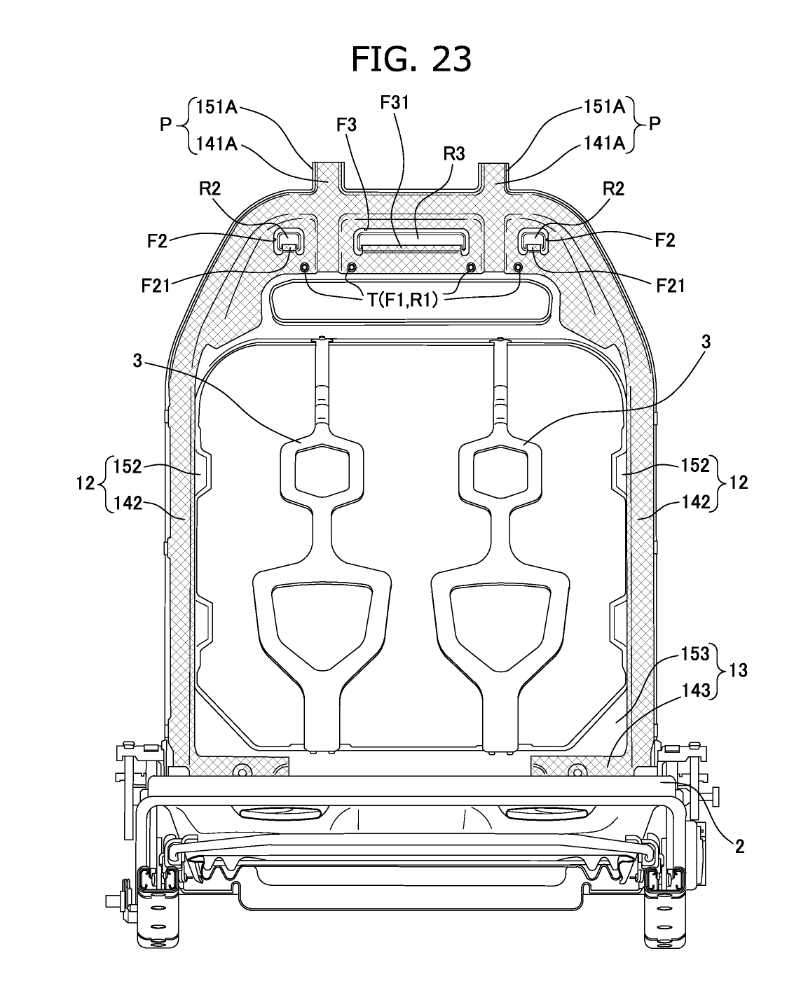

FIG. 23 is a front view of the seatback frame 1, illustrating the front frame 14 by diagonal lines for easy understanding. However, this kind of patterning or processing is not actually applied, and the processing is arbitrary.

Front Frame

First, the front frame 14 will be described.

In the front frame 14, most of the front-side upper frame 141, the front-side side frames 142 and 142, and a front-side lower frame 143 are bulged forward.

As shown in FIGS. 22, 23, 25, and the like, in this embodiment, two front-side holding portions 141A and 141A extending in the up and down direction are formed in the front-side upper frame 141.

The front-side holding portions 141A and 141A are arranged in two lines in parallel with each other in the width direction, and protrude forward such that the horizontal sections of them become a substantially U shape.

That is, the headrest pillar HP is maintained in a hollow portion.

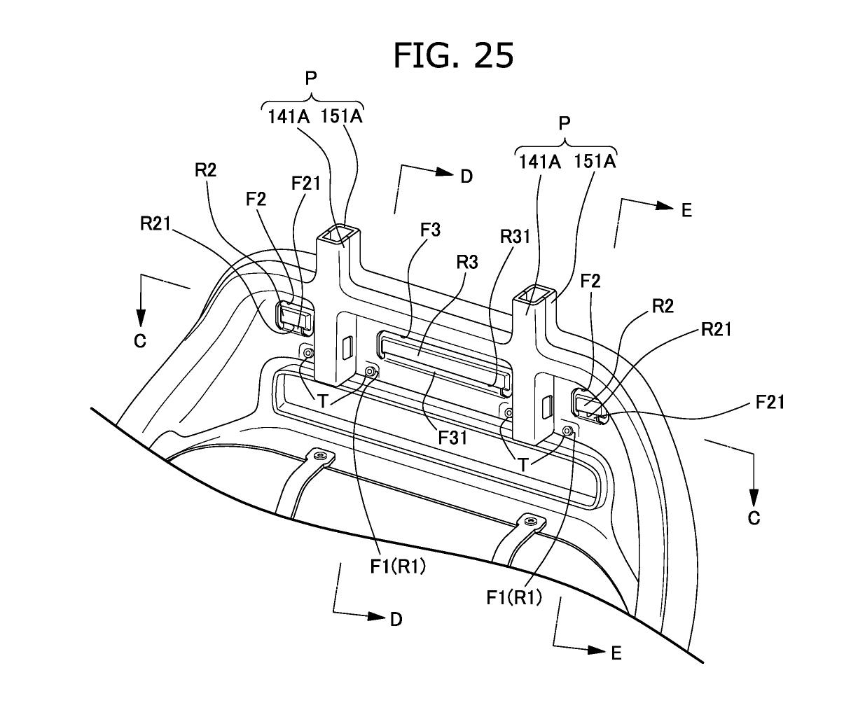

The front-side holding portion 141A as shown in FIG. 25 is formed to protrude forward. When the front-side holding portion 141A is combined with the rear-side upper frame 151, the rear-side upper frame 151 and the front-side holding portion 141A form a cylindrical shape (a cylinder with the horizontal cross section in a substantially rectangular shape), and its inner opening is configured to extend in the up and down direction.

Front-side first rivet through holes F1 and F1 are respectively formed in positions that sandwich the lower end of the front-side holding portion 141A in the width direction.

There are two front-side holding portions 141A, so that the four front-side first rivet through holes F1 are formed.

Further, outside the front-side holding portions 141A and 141A, first protruding holes F2 and F2 are respectively formed in a substantially rectangular shape.

A first retaining claw portion F21 extending in the upper direction is formed from the lower end side of the first protruding hole F2.

The first retaining claw portion F21 rises while protruding forward once from the lower edge side of the first protruding hole F2 with its free end escaped rearward.

That is, the first retaining claw portion F21 has its intermediate point formed as an uncinated piece protruding forward.

A second protruding hole F3 with a substantially rectangular shape extending in the width direction is formed between the front-side holding portions 141A and 141A.

A second retaining claw portion F31 extending in the upper direction is formed from the lower end side of the second protruding hole F3.

The second retaining claw portion F31 rises while protruding forward once from the lower edge side of the second protruding hole F3 with its free end escaped rearward.

That is, the second retaining claw portion F31 has its intermediate point formed as an uncinated piece protruding forward.

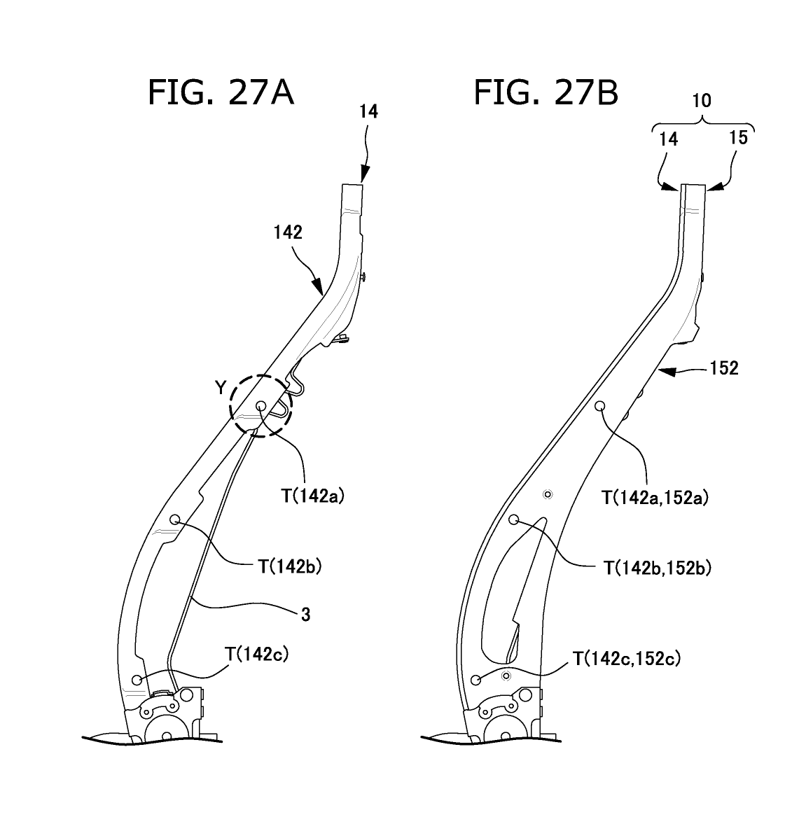

As shown in FIG. 27A, the upper portion, intermediate portion, and lower portion of the outer side surface of the front-side side frame 142 are provided with a front-side second rivet through hole 142a, a front-side third rivet through hole 142b, and a front-side fourth rivet through hole 142c, respectively.

The front-side lower frame 143 bridges the lower ends of the front-side side frames 142 and 142.

Rear Frame

Next, the rear frame 15 will be described.

In the rear frame 15, the rear-side upper frame 151 has a basic structure including a flat-plate shaped rear-side upper frame base 151B, a rear-side frame covering edge 151C standing forward from an outer periphery of the base, and two rear-side holding portions 151A and 151A protruding upward.

The rear-side frame covering edge 151C is provided to cover the outer periphery of the front-side upper frame 141.

Each of the rear-side holding portions 151A and 151A is a portion having a horizontal section in a substantially U shape and protruding upward from the rear-side frame covering edge 151C.

The opening with the substantially U-shaped horizontal section is opened in the direction of the front surface. The protruding position of the portion is a position that matches the position in which the front-side holding portions 141A and 141A are placed when assembling the front-side upper frame 141 and the rear-side upper frame 151.

Thus, the front-side holding portion 141A, 141A, the rear-side holding portion 151A, 151A, and the rear-side upper frame base 151B form two cylindrical pillar disposing portions P.

The term “pillar disposing portion P” corresponds to a combination of the “front-side holding portion 14h” and the “rear-side holding portion 15h” in the first embodiment, and thus corresponds to a “support portion” described in the embodiment.

Note that in an upper portion of the pillar disposing portion P, the front-side holding portions 141A and 141A and the rear-side holding portions 151A and 151A form the cylindrical portion having a substantially rectangular horizontal section, while in a lower portion of the pillar disposing portion P, the front-side holding portions 141A and 141A and the rear-side upper frame base 151B form another cylindrical portion to communicate with the upper portion. The thus-obtained cylindrical portions serve as the pillar disposing portion P.

As shown in FIGS. 22, 24, 25, and the like, in this embodiment, the rear-side upper frame 151 is provided with the two rear-side holding portions 151A and 151A protruding upward.

Rear-side first rivet through holes R1 and R1 are respectively formed in the positions which nip the lower ends of the rear-side holding portions 151A in the width direction and which match with the position of the front-side first rivet through holes F1 and F1 upon assembling the front frame 14 with the rear frame 15.

There are two rear-side holding portions 151A and 151A so that the four rear-side first rivet through holes R1 are formed.

Further, first retaining protrusions R2 and R2 protruding forward each are formed in a substantially rectangular shape outside the rear-side holding portions 151A and 151A, respectively.

A first retaining slit R21 extending in the width direction is formed under the first retaining protrusion R2.

The first retaining protrusions R2 and R2 are formed to protrude forward from the respective first protruding holes F2 and F2 formed in the front frame 14 when assembling the front frame 14 to the rear frame 15. In this state, the first retaining claw portion F21 is retained by a first retaining slit R21.

At this time, the first retaining claw portion F21 has its intermediate point formed as an uncinated piece slightly protruding forward. The first retaining claw portion F21 can be retained along the protruding shape on the lower side of the first retaining protrusion R2, while inserting its free end into the first retaining slit R21 from the front to rear side.

A second retaining protrusion R3 is formed between the rear-side holding portions 151A and 151A to protrude forward in a substantially rectangular shape elongated in the width direction.

A second retaining slit R31 is formed by cutting the lower end side of the second retaining protrusion R3 to extend in the width direction.

The second retaining protrusion R3 is formed to protrude forward from the second protruding hole F3 formed in the front frame 14 when the front frame 14 and the rear frame 15 are assembled together. In this state, the second retaining claw portion F31 is retained by the second retaining slit R31.

At this time, the second retaining claw portion F31 has its intermediate point formed as an uncinated piece protruding forward. The second retaining claw portion F31 can be retained along the protruding shape on the lower side of the second retaining protrusion R3 with its free end side inserted into the second retaining slit R31 from the front to the rear side.

As shown in FIG. 27B, the upper portion, intermediate portion, and lower portion of the outer surface of the rear-side side frame 152 are provided with a rear-side second rivet through hole 152a, a rear-side third rivet through hole 152b, and a rear-side fourth rivet through-hole 152c, respectively.

The rear-side lower frame 153 bridges the lower ends of the rear-side side frames 152 and 152, and has its central portion protruding forward in the rectangular uncinated shape to be retained by the center of the front-side lower frame 143.

Joint Structure Between Front Frame and Rear Frame

The joint structure between the “front frame 14” and the “rear frame 15” formed in the way described above will be summarized below.

The joint structure is mainly classified into “joining with a rivet T”, and “joining by a retaining relationship”.

Note that in this embodiment, a rivet T is used as a “latch” described in the embodiments. However, the latch is not limited thereto. Any latch that can couple the front frame 14 with the rear frame 15 may be used.

Referring to FIGS. 25, 26, 29, 32, and 33, the joining in the engagement relationship will be described.

When assembling the front frame 14 and the rear frame 15, first, the front-side upper frame 141 and the rear-side upper frame 151 are combined together.

At this time, the first retaining protrusions R2, R2 formed in the rear-side upper frame 151 are assembled to respectively protrude forward from the first protruding holes F2 and F2 formed in the front-side upper frame 141. The first retaining claw portions F21 and F21 formed in the front-side upper frame 141 are press-fitted and retained into and by the first retaining slits R21 and R21 formed in the rear-side upper frame 151, from the lower side.

At the same time as this time, the second retaining protrusion R3 formed in the rear-side upper frame 151 is assembled to protrude forward from the second protruding hole F3 formed in the front-side upper frame 141. The second retaining claw portion F31 formed in the front-side upper frame 141 is press-fitted and retained into and by the second retaining slit R31 from the lower side.

In this state, the rectangular uncinated shape of the central portion of the rear-side lower frame 153 is retained by the center of the front-side lower frame 143, and the rear-side side frames 152 and 152 hold the front-side side frames 142 and 142 from the outside (while the rear-side side frames 152 and 152 cover the outside of the front-side side frames 142 and 142).

At this time, the first retaining claw portion F21 has its intermediate point formed as the uncinated shaped piece slightly protruding forward. Thus, the first retaining claw portion F21 can be retained along the protruding shape on the lower side of the first retaining protrusion R2 with its free end side inserted into the first retaining slit R21 from the front to the rear side.

Likewise, the second retaining claw portion F31 has its intermediate point formed as the uncinated shaped piece slightly protruding forward. Thus, the second retaining claw portion F31 can be retained along the protruding shape on the lower side of the second retaining protrusion R3 with its free end side inserted into the second retaining slit R31 from the front to the rear side.

The first retaining protrusion R2 and the second retaining protrusion R3 are formed as the rectangular protrusion protruding forward.

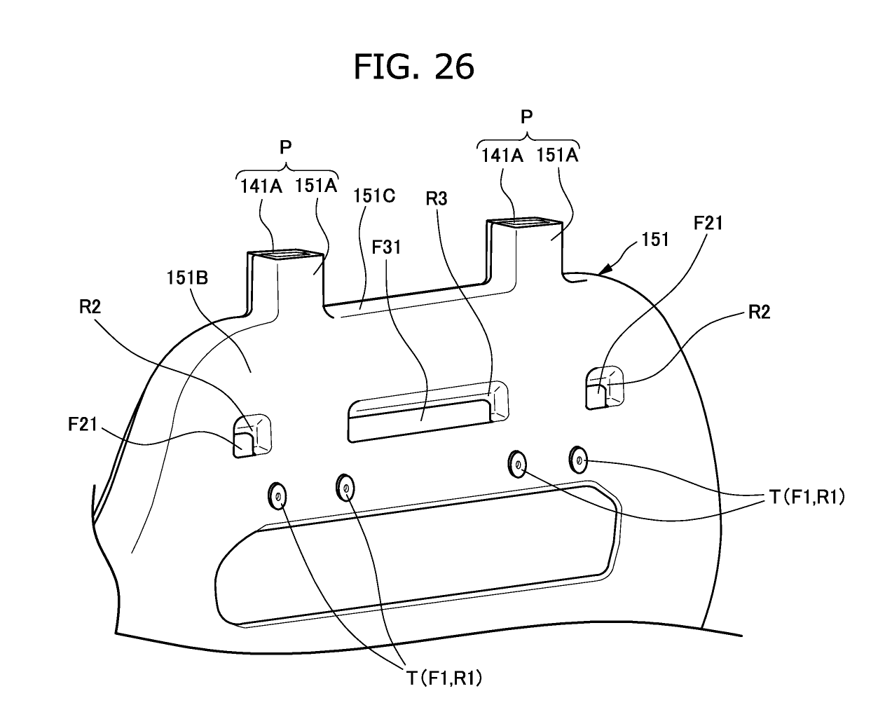

Thus, when viewing the rear-side upper frame 151 from the rear side, as shown in FIGS. 26, 29, 32, 33, and the like, each of the first retaining protrusion R2 and the second retaining protrusion R3 becomes a recessed portion. Thus, the free ends of the first retaining claw portions F21 and F21 and the second retaining claw portions F31, that is, the ends invading the back surface through the first retaining slits R21 and R21 and the second retaining slit R31 are accommodated in the recessed portions located on the back surface side of the first retaining protrusion R2 and the second retaining protrusion R3.

Thus, the ends of the claw portions can be prevented from protruding to the outside of the back surface of the rear-side upper frame 151.

The first retaining protrusions R2 and R2 formed in the rear-side upper frame 151 respectively protrude forward from the first protruding holes F2 and F2 formed in the front-side upper frame 141. Further, the second retaining protrusion R3 formed in the rear-side upper frame 151 protrudes forward from the second protruding hole F3 formed in the front-side upper frame 141. Thus, the front-side upper frame 141 and the rear-side upper frame 151 can be positioned when assembling these frames, thereby improving the assembly workability.

Next, the joining with the rivet T will be described with reference to FIGS. 25, 26, 27, 28, 29, 30, and 31.

As mentioned above, four front-side first rivet through holes F1, which are positioned to sandwich the lower ends of the two front-side holding portions 141A in the width direction, are configured to communicate with four rear-side first rivet through holes R1, which are positioned to sandwich the lower ends of the two rear-side holding portions 151A in the width direction. The rivets T are inserted into the communication holes to caulk these frames, whereby the front-side upper frame 141 is joined to the rear-side upper frame 151.

Specifically, the rear-side first rivet through hole R1 formed in the rear-side upper frame 151 is configured to have a slightly larger diameter than that of the front-side first rivet through hole F1 formed in the front-side upper frame 141. The rivet T penetrates through these through holes from the rear side to the front side (that is, from a side of the rear-side upper frame 151 to a side of the front-side upper frame 141), and thereby both through holes are caulked on the front side, whereby both the frames are joined together.

In this embodiment, the joining with the rivets T is also performed in the side frame 12 as shown in FIGS. 27A, B or the like.

As shown in FIG. 27A, the upper portion, intermediate portion, and lower portion of the outer surface of the front-side side frame 142 are provided with the front-side second rivet through hole 142a, the front-side third rivet through hole 142b, and the front-side fourth rivet through hole 142c, respectively. On the other hand, as shown in FIG. 27B, the upper portion, intermediate portion, and lower portion of the outer surface of the rear-side side frame 152 are provided with the rear-side second rivet through hole 152a, the rear-side third rivet through hole 152b, and the rear-side fourth rivet through-hole 152c, respectively.

When combining the front frame 14 and the rear frame 15, the front-side second rivet through hole 142a and the rear-side second rivet through hole 152a communicate with each other; the front-side third rivet through hole 142b and the rear-side third rivet through hole 152b communicate with each other; and the front-side fourth rivet through hole 142c and the rear-side fourth rivet through 152c communicate with each other. The rivets T are inserted into these communication holes and caulked together, thereby joining the frames.

That is, both the side frames 12 and 12 are joined together at the upper, intermediate, and lower parts thereof by the rivets T.

At this time, the communication directions on a side of the side frame 12 between the front-side second rivet through hole 142a and the rear-side second rivet through hole 152a, between the front-side third rivet through hole 142b and the rear-side third rivet through hole 152b, and between the front-side fourth rivet through hole 142c and the rear-side fourth rivet through hole 152c are set to the width direction. The communication directions on the upper frame 11 side between the four front-side first rivet through holes F1 and the four rear-side first rivet through holes R1 is set to the front to back direction.

That is, both the communication directions are different from each other. Especially, in this embodiment, these communication directions are displaced by about 90 °.

Thus, in both communication states, the rivets T are fastened to press the front and back surfaces in the direction that peels off the front and back surfaces, which can prevent the peeling of the front and back surfaces, thereby improving the rigidity of the structure.

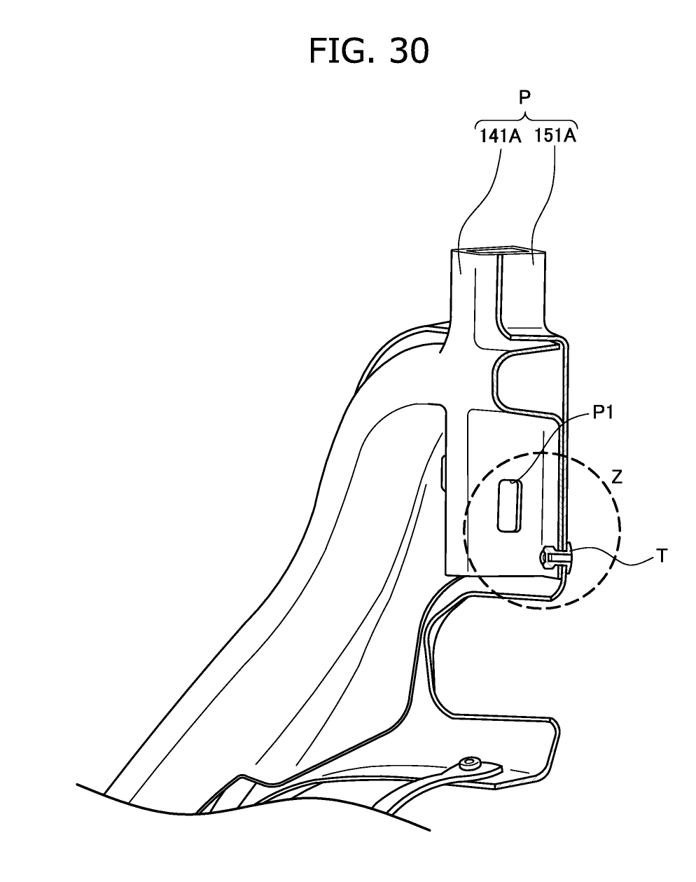

The pillar disposing portion P is provided with a pillar retaining hole P1 for retaining the headrest pillar HP (see FIGS. 22 and 30, and the like).

The pillar retaining hole P1 will be briefly described.

As is well known, the headrest pillar HP includes a cushion portion for supporting the head of an occupant, and two rod-like bars extending from the lower portion of the cushion portion, and having free ends thereof coupled to the seatback frame 1.

The rod-like bar is normally attached to the pillar disposing portion P formed in the seatback frame 1, through the headrest guide member.

The headrest guide member is a known member, and includes a framework that is fitted to the inner diameter of the pillar disposing portion P with the free end of the rod-like bar fitted and inserted into a hole formed from the bottom surface of the framework in the up and down direction.

At this time, the headrest guide member has on its side surface, a guide member side protrusion. When the seatback guide member with the headrest pillar HP attached thereto is fitted and inserted into the pillar disposing portion P, the guide member side protrusion is retained by the pillar retaining hole P1, whereby the guide member is attached to the pillar disposing portion P.

Thus, the pillar retaining hole P1 is formed to retain the headrest guide member, while the rivet T is disposed in a position located in the vicinity of the pillar retaining hole P1 and not superimposing over an opening of the pillar retaining hole (see FIG. 30).

The rivets are formed in this way so that the fixing by use of the rivets T has an effect of reinforcing the portion of the pillar retaining hole P1 without inhibiting the detachment workability of the headrest pillar HP through the guide member.

Specifically, the rear-side second rivet through hole 152a, the rear-side third rivet through hole 152b, and the rear-side fourth river through hole 152c, which are formed in the rear-side side frame 152, each are configured to have a slightly large diameter than that of the corresponding front-side second rivet through hole 142a, front-side third rivet through hole 142b, and front-side fourth rivet through hole 142c, respectively. The rivets T penetrate the through holes from the outer side to the inner side (that is, from the rear-side side frame 152 side to the front-side side frame 142 side) and are caulked together on the inner side, so that both side frames are joined together.

In this way, the frame main body 10 according to the present embodiment is assembled.

Such assembly can ensure the higher assembly rigidity.

Further, this embodiment can perform positioning and achieve the joint state by the simple structure, thereby improving workability.

Since the joint is performed by the rivets without using a heavy member, such as a bolt, this embodiment can contribute to the reduction in weight, while effectively preventing the occurrence of cracks due to fastening of the resin material or the like.

When attaching the front frame 14 and the rear frame 15, bonding with an adhesive can be used in combination.

### REFERENCE NUMERALS

S vehicle seat
S1 seatback, S2 seat cushion
S3 headrest
HP headrest pillar
G headrest guide member (connection member)
G1 head
G2 frame fitted portion
G21 engagement protrusion
G3 neck portion
G4 pillar shaft through hole
1 seatback frame
10 frame main body
11 upper frame
12 side frame
13 lower frame
14 front frame
14b inner surface
14h front-side holding portion (support portion)
14h1 upper portion of front-side holding portion
140 front-side bottom portion
141 front-side inner surface
141a front-side engagement hole portion
142 front-side outer surface
14h2 lower portion of front-side holding portion
14i convex portion
14k cutout portion
21 front side nipping portion
22 front side convex portion
23 tongue-shaped protrusion
24 top surface
25 upper surface, 26 front surface, 27 lower surface
15 rear frame
15a outer edge wall, 15b inner edge wall
15h rear-side holding portion (support portion)
150 rear-side bottom portion
151 rear-side inner surface
151a rear-side engagement hole portion
152 rear-side outer surface
15i rear frame hole portion
15j flange
31 back side nipping portion
32 back side convex portion
33 tongue-shaped protrusion (movement restriction portion)
34 top surface
35 upper surface, 36 rear surface, 37 lower surface
K guide member attachment portion
Q rib member
RH hole
D gap, Dr adjacent hole
2 seat cushion frame
3 occupant support member
Second Embodiment
S vehicle seat
S1 seatback
S2 seat cushion
S3 headrest
HP headrest pillar
seatback frame
10 frame main body
11 upper frame
12 side frame
13 lower frame
14 front frame
141 front-side upper frame
141A front-side holding portion
F1 front-side first rivet through hole
F2 first protruding hole
F21 first retaining claw portion (claw portion)
F3 second protruding hole
F31 second retaining claw portion (claw portion)
142 front-side side frame
142a front-side second rivet through hole
142b front-side third rivet through hole
142c front-side fourth rivet through hole
143 front-side lower frame
15 rear frame
151 rear-side upper frame
151A rear-side holding portion
151B rear-side upper frame base
R1 rear-side first rivet through hole
R2 first retaining protrusion
R21 first retaining slit (slit)
R3 second retaining protrusion
R31 second retaining slit (slit)
151C rear-side frame covering edge
152 rear-side side frame
152a rear-side second rivet through hole
152b rear-side third rivet through hole
152c rear-side fourth rivet through hole
153 rear-side lower frame
P pillar disposing portion (support portion)
P1 pillar retaining hole
T rivet (latch)
2 seat cushion frame
3 occupant support member

1. A vehicle seat on which an occupant sits, comprising:
at least a seatback frame that supports a back of the occupant, comprising:
at least a frame main body comprising:
a front frame constituting a front portion; and a rear frame constituting a rear portion; and
a cylindrical support portion for supporting a headrest that is provided at a combined portion between the front frame and the rear frame;
wherein the support portion has an opening into which a connection member for coupling between the headrest and the frame main body is inserted.

2. The vehicle seat according to claim 1, wherein the support portions are provided at both right and left sides of the front frame other than the center thereof, on an occupant side of the front frame while protruding toward the occupant side.

3. The vehicle seat according to claim 1, wherein:
a plurality of the support portions are provided, and
a convex portion protruding forward or rearward is provided between the support portions.

4. The vehicle seat according to claim 3, wherein a front side end of the convex portion is positioned on a rear side with respect to a front side end of the support portion.

5. The vehicle seat according to claim 1 wherein:
the frame main body is provided in a frame shape, the frame main body comprising:
side frames disposed spaced apart from each other in a right and left direction;
a lower frame bridging lower ends of the side frames; and
an upper frame bridging upper ends of the side frames,
the support portion is provided in the upper frame, and
an other frame of the front frame and the rear frame different from the frame with the support portion provided therein is provided with a flange that is positioned opposed to the support portion in an up and down direction in an assembly state.

6. The vehicle seat according to claim 5, wherein:
the flange is disposed in a position that does not interfere with the connection member while the frame main body is assembled, and
the connection member for coupling between the headrest and the frame main body is disposed in the support portion.

7. The vehicle seat according to claim 6, wherein the flange is provided under the connection member.

8. The vehicle seat according to claim 1, wherein a bonding surface to which an adhesive is applied is provided at a surface of the support portion disposed in a vehicle width direction.

9. The vehicle seat according to claim 1, wherein:
the seatback frame comprises an occupant support member disposed between both ends of the frame main body in a width direction of the vehicle seat, the occupant support member being adapted to support the occupant sitting on the vehicle seat, from the back side,
a front side nipping portion provided in a front frame piece and a back side nipping portion provided in a rear frame piece are engaged with each other to provide the frame main body, and
the occupant support member is nipped between the front side nipping portion and the back side nipping portion to be attached to the frame main body.

10. The vehicle seat according to claim 1, wherein:
the vehicle seat is provided to have a resin seat frame comprising the seatback frame as a skeleton, and
the front frame and the rear frame are joined with each other through a latch.

11. The vehicle seat according to claim 10, wherein:
the seat frame is the seatback frame,
the frame main body constituting the seatback frame is provided in a frame shape, the frame main body comprising:
side frames disposed spaced apart from each other in a right and left direction,
a lower frame bridging lower ends of the side frames, and
an upper frame comprising the support portion, while bridging upper ends of the side frames, and
a joint portion with the latch is provided in at least one position on a lower side of the support portion.

12. The vehicle seat according to claim 11, wherein:
the joint portions with the latches are provided, and
the joint portions with the latches are positioned to sandwich therebetween a lower side of the support portion.

13. The vehicle seat according to claim 12, wherein:
the joint portion with the latch is further provided in the side frame, and
a direction in which the latch penetrates the upper frame is different from a direction in which the another latch penetrates the side frame.

14. The vehicle seat according to claim 1, wherein:
a claw portion is provided on one of the front frame and the rear frame,
a slit capable of being engaged with the claw portion is provided on the other one of the front frame and the rear frame, and
the claw portion is retained in the slit so that the front frame and the rear frame are joined to each other.

15. The vehicle seat according to claim 13, wherein:
the front frame is provided with a protruding hole,
the claw portion protrudes from a portion of a peripheral edge of the protruding hole,
the rear frame is provided with a retaining protrusion that protrudes forward,
the slit is provided in the retaining protrusion, and
the retaining protrusion is exposed forward from the protruding hole.

16. The vehicle seat according to claim 15, wherein:
the protruding hole is provided in an upper portion,
the claw portion extends from a peripheral edge of the protruding hole in the vicinity of the latch,
the slit is provided by being cut in a position of the retaining protrusion that matches a position where the claw portion is disposed when the front frame and the rear frame are combined,
a free end of the claw portion is inserted into the slit from a front side toward a rear side, and
the free end of the claw portion is disposed inside a concave portion at a backside of the retaining protrusion.

17. The vehicle seat according to claim 14, wherein the claw portion and the slit are disposed in at least one of a position outside the support portion, and a position between the support portions.

18. The vehicle seat according to claim 14, further comprising a plurality of the claw portions, wherein the claw portions are provided in such positions as to sandwich a lower portion of the support portion therebetween.

19. The vehicle seat according to claim 14, wherein at least the one claw portion is provided in between the latches.

20. The vehicle seat according to claim 14, wherein at least the one latch is disposed between the claw portion and the support portion.

21. The vehicle seat according to claim 14, wherein:
a pillar retaining hole for retaining the headrest is provided at a side surface of the support portion, and
the latch is disposed in a position other than an opening of the pillar retaining hole and in the vicinity of the pillar retaining hole.
